(19) United States
(12) Patent Application Publication
(10) Pub. No.: US 2026/0220075 A1
(43) Pub. Date: Jul. 30, 2026

(54) METHODS AND APPARATUS FOR MIPI SOUNDWIRE INTEGRATION

(71) Applicant: Intel Corporation, Santa Clara, CA (US)

(72) Inventor: Aruni NELSON, Rocklin, CA (US)

(21) Appl. No.: 19/630,521

(22) Filed: Mar. 27, 2026

(51) Int. Cl. G06F 13/42; G06F 3/16

(52) U.S. Cl. CPC G06F 13/4282; G06F 3/165; G06F 2213/0042; G06F 2213/4002

(57) ABSTRACT

A device including: an upstream-facing port configured to communicate with a host controller via USB signaling; at least one downstream-facing port configured to communicate with one or more audio bus peripheral devices; and processing circuitry configured to: process first audio bus data received via USB transactions through the upstream-facing port; cause the first audio bus data to be forwarded to the one or more audio bus peripheral devices via the audio bus protocol through the at least one downstream-facing port, process second audio bus data received from the one or more audio bus peripheral devices via the audio bus protocol through the at least one downstream-facing port; and cause the second audio bus data to be forwarded to the host controller via USB transactions through the upstream-facing port.

### BACKGROUND

Modern computing platforms, including personal computers, laptop computers, tablet computers, and mobile handsets, incorporate audio subsystems that interact with audio peripheral devices to provide audio input and output functionality. Communication between a computing platform and its associated audio peripheral devices is typically managed by a dedicated audio interconnect integrated into the system-on-chip of the computing platform.

A system-on-chip integrates the central processing unit, memory controllers, and communication interface controllers of the computing platform onto a single die. The audio interconnect controller within the system-on-chip can initiate audio data transfers, configure audio peripheral devices by writing to configuration registers, and manage audio streaming between the computing platform and multiple concurrently active audio peripheral devices. As audio interconnect standards evolve, deploying a new audio interconnect standard on a computing platform typically requires integrating the corresponding controller logic into the system-on-chip. Integrating new controller logic into a system-on-chip requires a full design and validation cycle, representing a substantial investment of engineering resources spanning several years from design initiation to production silicon availability.

### BRIEF DESCRIPTION OF FIGURES

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 illustrates a block diagram of an example computing system;

FIG. 2 illustrates an example block diagram of a system in accordance with various aspects described herein;

FIG. 3 illustrates an example block diagram of a device 301 in accordance with various aspects described herein;

FIG. 4 illustrates an example block diagram of a system in accordance with various aspects described herein;

FIG. 5 illustrates an example block diagram of a system in accordance with various aspects described herein;

FIG. 6 illustrates an example of a software stack architecture in accordance with various aspects described herein;

FIG. 7 shows an example of a method;

FIG. 8 shows an example of a method.

### DESCRIPTION

The present disclosure relates to electronic devices for audio data communication. More specifically, the present disclosure relates to electronic devices configured to interface between different communication protocols for the transport of audio data between a host system and one or more audio peripheral devices.

Audio peripheral devices include, but are not limited to, audio codecs, digital microphone assemblies, audio amplifiers, and speaker drivers. An electronic device of the kind described herein may perform protocol translation, data format conversion, and physical-layer adaptation to ensure that audio data generated by the host system is correctly delivered to the audio peripheral devices, and that audio data captured by the audio peripheral devices is correctly delivered to the host system. Various aspects described herein may include devices that provide bridging functionality between a communication protocol used on the host side and a communication protocol used on the audio peripheral device side, enabling the host system and the audio peripheral devices to communicate without requiring each side to natively implement the communication protocol used by the other.

Reusing communication infrastructure that is already established on a computing platform to support new types of peripheral devices, rather than integrating dedicated new controller hardware into the system-on-chip, represents an approach to reducing the time and cost associated with adopting new peripheral interface standards. A computing platform incorporates communication interfaces that are mature, widely deployed, and established in terms of electrical, protocol, and software behavior. Such existing communication infrastructure can include physical-layer transceivers, host controller hardware, protocol stacks, device class frameworks, and associated driver software that have been validated and deployed across a wide installed base of platforms.

When a new type of audio peripheral device employing a new communication protocol emerges, an intermediate device that bridges between the new audio peripheral protocol and an existing communication interface already present on the platform allows the host system to communicate with the new audio peripheral devices via the existing communication infrastructure, without requiring modification to the system-on-chip. This approach can reduce the time required for a computing platform to support new audio peripheral device types, and can enable audio peripheral devices employing new interconnect standards to be deployed on platforms whose system-on-chip designs predate the emergence of those standards.

Modern computing platforms rely heavily on the Universal Serial Bus (USB) as a general-purpose communication interface for connecting peripheral devices to a host system. The USB infrastructure includes a host controller that manages USB communication, a physical-layer transceiver that handles electrical signaling on the USB bus, one or more USB hubs that extend the USB topology to additional downstream ports, and a USB software stack that manages device enumeration, configuration, and data transfer. The USB software stack includes a USB host controller driver, USB class drivers, and higher-level software components running on the host processor. USB infrastructure is present on contemporary computing platforms, including personal computers, laptop computers, tablet computers, and mobile handsets. The USB Implementers Forum defines and maintains the USB specification, which governs the electrical, protocol, and software behavior of USB devices and host controllers. USB device classes provide a standardized framework by which a host system identifies and configures USB devices according to their functional category. USB descriptors are data structures exposed by a USB device to a host controller during enumeration, providing the host controller with information about the device's identity, capabilities, configuration, and supported device class.

Audio interconnect standards designed for embedded audio systems have emerged to address requirements of modern computing platforms in areas including power efficiency, low latency, multi-device support, and reduced wiring complexity compared to legacy audio interfaces. Such audio interconnect standards can define their own physical-layer signaling, protocol, framing, addressing, and device management topology, independently from USB. An audio interconnect of this kind includes a manager entity that controls the audio bus and one or more peripheral devices that respond to commands from the manager entity. The manager entity initiates audio data transfers, manages device configuration, and coordinates timing across all peripheral devices sharing the bus. The physical-layer signaling defined by such an audio interconnect standard specifies the electrical characteristics of the signal lines, including voltage levels, signaling modes, and line topology. Audio interconnect standards of this kind support multi-device configurations in which multiple audio peripheral devices share a common physical connection to the manager entity, enabling a single audio bus to serve multiple audio peripheral devices simultaneously.

Native integration of a new audio interconnect standard into a computing platform requires dedicated controller intellectual property implementing the audio interconnect manager function to be integrated into the system-on-chip of the platform. Audio peripheral devices employing new audio interconnect standards may offer improvements in power efficiency, audio quality, and functional capability relative to legacy audio peripheral devices. The multi-year gap between the emergence of such new audio peripheral devices and the availability of system-on-chip designs incorporating native support for the corresponding audio interconnect standard represents a period during which computing platforms cannot natively support the new audio peripheral device types without a mechanism to bridge between the new audio interconnect standard and the existing communication infrastructure of the platform.

The USB is a standardized communication architecture defining the electrical, mechanical, and protocol characteristics of communication between a host system and connected peripheral devices. The USB architecture includes a host controller that initiates and manages all USB communication, a defined transaction model in which the host controller initiates each USB transaction and a connected USB device responds, and a layered protocol stack running on the host processor that manages device discovery, configuration, and data transfer. The USB specification defines a device class framework by which a USB device identifies its functional category to the host controller during a process known as USB enumeration. During USB enumeration, the host controller requests USB descriptors from the connected USB device. USB descriptors are standardized data structures that provide the host controller with information about the device's identity, configuration, capabilities, and device class membership, enabling the host controller and the USB software stack to load the appropriate device class driver and configure the device for operation.

The USB Type-C connector and interface specification defines a reversible connector and associated interface that supports multiple signaling modes over a common physical connector. The USB Type-C specification is widely implemented across personal computers, laptop computers, tablet computers, and mobile handsets. The USB Type-C interface supports USB 2.0 signaling, USB 3.x SuperSpeed signaling, and alternative signaling modes depending on the configuration negotiated between connected devices. A USB Type-C connection may carry USB 2.0 differential signaling on the D+ and D− lines defined within the USB Type-C connector, or may carry USB 3.x signaling on the SuperSpeed differential pairs, or may carry alternative mode signaling on the high-speed lanes of the connector when a supported alternative mode is negotiated. The flexibility of the USB Type-C interface enables a single physical connector to serve multiple communication functions on a computing platform.

A USB 2.0 connection is a communication link conforming to the USB 2.0 specification, operating using full-speed or high-speed differential signaling on D+ and D− signal lines at USB 2.0 voltage levels. A USB 2.0 connection provides a data transfer rate of up to 480 megabits per second at high speed. In some embodiments, the USB 2.0 connection is an embedded USB 2.0 connection. An embedded USB 2.0 connection, also referred to as eUSB2, is a variant of USB 2.0 designed for chip-to-chip communication within a computing platform, operating at reduced signaling voltage levels relative to a native USB 2.0 connection. An eUSB2 connection maintains full USB 2.0 protocol compatibility while reducing power consumption and enabling shorter signal trace routing between integrated circuits on the platform. In some implementations, an eUSB2 connection employs a repeater component to convert between the low-voltage eUSB2 signaling used between integrated circuits on the platform and the standard USB 2.0 voltage levels used at the external USB connector, as described in the eUSB2 Physical Layer Supplement to the USB Revision 2.0 Specification.

The apparatuses and methods of this disclosure may utilize or be related to USB technologies. While some examples may refer to specific USB technologies, the examples provided herein may be similarly applied to various other interfaces for communicating audio data, both existing and not yet formulated, particularly in cases where such interface technologies share similar features as disclosed regarding the following examples. Various exemplary USB technologies that the apparatuses and methods described herein may utilize include operations in accordance with various USB specifications including, but are not limited to: USB 2.0 specification (08/10/2021), USB 2.0 Cable and Connector Class Document (01/08/2007), any USB 3.x base specification such as USB 3.2 rev 1.1 (03/06/2022), USB Power Delivery Specification (20/04/2023), USB Type-C Connector Specification Release 2.2 (18/10/2022), USB Type-C and Power Delivery Source Power Requirements (24/05/2021), USB Type-C Bridge Specification (23/10/2018), USB Type-C Locking Connector Specification (09/03/2016), USB4 Specification (28/10/2022) and other existing, developing, or future interface technologies. It is to be noted that aspects may be implemented in accordance with any version of the listed specifications other than the listed ones for which publication dates are provided.

The MIPI SoundWire protocol is an audio interconnect standard defined by the MIPI Alliance for use in embedded audio systems within mobile and personal computer platforms. MIPI SoundWire uses a synchronous bus including a clock line that carries a clock signal from the manager device to one or more peripheral devices, and one or more data lines that carry audio and control information. The MIPI SoundWire protocol defines a manager entity that controls the bus and one or more target peripheral entities that respond to commands from the manager entity. MIPI SoundWire supports multi-drop bus configurations in which multiple peripheral devices share a common set of signal lines connected to the manager entity. The MIPI SoundWire protocol is used in embedded audio systems to transport audio payload data, such as pulse-code modulation audio samples, and control data, such as register read and write commands and interrupt notifications, between the manager entity and the connected audio peripheral devices.

The MIPI SoundWire I3S protocol, referred to herein as SWI3S, is a newer audio interconnect standard defined by the MIPI Alliance. SWI3S is characterized as a two-pin, multi-drop, half-duplex interconnect. SWI3S carries both audio payload data, including audio streams such as pulse-code modulation audio samples, and control data, including configuration commands, register access operations, and status information, on a single link. SWI3S supports both single-ended and differential physical-layer variants. In the single-ended variant, referred to as the forwarded-bit-clock single-ended PHY, the two-pin interface includes a clock line carrying a forwarded bit clock signal from the manager to the peripheral devices as a single-ended signal, and a data line carrying a data signal as a single-ended signal shared between the manager and the peripheral devices. In the differential variant, referred to as the differential low-voltage PHY, the two-pin interface includes a differential pair of lines carrying a differential signal, providing improved electromagnetic compatibility performance suitable for system designs where signal integrity is a primary constraint. SWI3S supports multi-drop configurations in which up to twelve peripheral devices share a common physical connection to the manager entity. The half-duplex operation of SWI3S means that transmission from the manager to peripheral devices and reception from peripheral devices to the manager occur alternately on the shared physical connection, with the manager coordinating access to the shared medium.

The apparatuses and methods of this disclosure may utilize or be related to MIPI Alliance audio interconnect technologies. While some examples may refer to specific MIPI Alliance audio interconnect technologies, the examples provided herein may be similarly applied to various other audio bus interfaces, both existing and not yet formulated, particularly in cases where such interface technologies share similar features as disclosed in the following examples. Various exemplary MIPI Alliance audio interconnect technologies that the apparatuses and methods described herein may utilize include operations in accordance with various MIPI Alliance specifications including, but not limited to: MIPI SoundWire Specification Version 1.2 or Version 1.3 (September 2025), MIPI SoundWire Device Class for Audio Specification Version 1.1 (July 2025), MIPI SoundWire I3S Specification Version 1.0 (September 2025), and other existing, developing, or future audio interconnect interface technologies defined by the MIPI Alliance or other standards bodies. It is to be noted that aspects may be implemented in accordance with any version of the listed specifications other than the listed ones for which version numbers or publication dates are provided.

As used herein, an upstream-facing port is a port of a device that is configured to be connected to the host controller side of a USB communication topology. As used herein, a downstream-facing port is a port of a device that is arranged to be connected to the peripheral device side of a USB communication topology. In a USB hub, the upstream-facing port may be the single port through which the USB hub is connected to the host controller, or to a further hub that is itself connected toward the host controller, and through which all USB transactions initiated by the host controller enter the hub. In a USB hub, each downstream-facing port may be a port through which the USB hub provides a USB connection to a downstream USB device, or to a further USB hub that is itself connected toward the peripheral device side of the topology. In various aspects described herein, the upstream-facing port is the port through which the device receives USB transactions from, and transmits USB transactions to, the host controller. The downstream-facing port is the port through which the device transmits audio bus protocol frames to, and receives audio bus protocol frames from, one or more audio bus peripheral devices.

As used herein, a host controller is a hardware component integrated into or coupled to a host system that is configured for initiating and managing USB communication on the USB bus. The host controller can generate USB transactions directed to USB devices connected to the downstream side of the host controller, control the scheduling and sequencing of USB transactions on the USB bus, and arbitrate access to the USB bus among connected USB devices. The host controller may perform USB enumeration upon detecting the connection of a USB device by issuing a sequence of control transfer requests to the default control endpoint of the connected USB device to retrieve USB device descriptors, USB configuration descriptors, USB interface descriptors, USB endpoint descriptors, and any class-specific or vendor-specific descriptors exposed by the connected USB device. The host controller operates in accordance with a USB host controller interface specification that defines the memory-mapped register interface and operational behavior governing the host controller hardware.

As used herein, an audio bus is a communication bus dedicated to the transport of audio data between a controller or manager entity and one or more audio peripheral devices. As used herein, an audio bus protocol is the protocol that governs communication on an audio bus. An audio bus protocol may specify: the physical-layer signaling characteristics of the bus, including signal line count, voltage levels, signaling mode, and electrical termination; the framing structure that organizes the serial bitstream on the bus into discrete rows or frames; the addressing mechanism by which the controller or manager entity identifies individual peripheral devices on the shared bus; and the data formatting conventions by which audio payload data and control data are encoded within the frame structure for transmission on the bus. An audio bus protocol governs the physical and logical behavior of the audio bus independently of the USB transaction model. This also applies to examples where audio bus data is encapsulated as the payload of USB transactions for transport between the host controller and the device as described herein.

As used herein, an audio bus peripheral device is a device that communicates audio data with a controller or manager entity exclusively via an audio bus protocol. In some examples, an audio bus peripheral device does not implement a USB device controller and does not communicate via the USB protocol. Examples of audio bus peripheral devices include at least one of: audio codecs that perform digital-to-analogue conversion for audio playback and analogue-to-digital conversion for audio capture, digital microphone assemblies that output digitized audio samples representing captured acoustic signals, audio amplifiers that receive digital audio data and drive speaker transducers, and speaker drivers that convert digital audio input to acoustic output. Each audio bus peripheral device on an audio bus may be assigned a unique address by which the controller or manager entity addresses commands and data to that specific audio bus peripheral device. The controller or manager entity is configured for initiating all communication with each audio bus peripheral device, configuring each audio bus peripheral device by writing values to configuration registers within the audio bus peripheral device, and reading status registers within the audio bus peripheral device to determine its operating state.

As used herein, audio bus data is data that is formatted and communicated in accordance with an audio bus protocol between a controller or manager entity and one or more audio bus peripheral devices. Audio bus data includes audio payload data and control data. Audio payload data is data representing audio content encoded in a digital format, such as pulse-code modulation samples representing the amplitude of an audio waveform at discrete sampling intervals, for transport from the controller or manager entity to an audio bus peripheral device for playback, or from an audio bus peripheral device to the controller or manager entity for capture. Control data is data used to configure, manage, or interrogate the state of an audio bus peripheral device, and can include register write commands that set the values of configuration registers within an audio bus peripheral device to establish its operating mode, register read commands that retrieve the current values of registers within an audio bus peripheral device, and status response data that conveys the current operating state of an audio bus peripheral device to the controller or manager entity. The audio bus protocol can define the framing and scheduling structure by which audio payload data and control data are multiplexed within the serial bitstream of the audio bus.

As used herein, a USB transaction is the unit of data exchange on a USB bus, as defined in the USB specification. Each USB transaction can include three consecutive packet phases: a token phase in which the host controller transmits a token packet that identifies the transaction type, the address of the target USB device, and the address of the target endpoint within that USB device; a data phase in which either the host controller or the target USB device transmits a data packet carrying the payload of the transaction; and a handshake phase in which the recipient of the data packet transmits a handshake packet confirming successful reception of the data packet or indicating an error condition. The host controller may initiate every USB transaction on the USB bus. A USB data format is the format of the data packet payload of a USB transaction, which conforms to the USB specification in terms of packet structure, endpoint type, and transfer type. As used herein, audio bus data may be transported between the host controller and a device as the payload of USB transactions through the upstream-facing port, with the data packet payload of those USB transactions conforming to the USB data format defined by the USB specification.

Natively integrating a new audio bus protocol into a computing platform requires the corresponding audio bus controller to be implemented within the system-on-chip of the platform, which necessitates a full system-on-chip redesign cycle spanning several years. In various aspects described herein, a device may enable a host system to communicate with audio bus peripheral devices through the existing USB infrastructure of the platform, possibly without any modification to the system-on-chip, the USB host controller, or the USB physical-layer transceiver of the host platform. The device may include an upstream-facing port through which the device communicates with the host controller via USB signaling, at least one downstream-facing port through which the device communicates with audio bus peripheral devices via an audio bus protocol, and processing circuitry that bridges between USB transactions on the upstream side and audio bus protocol communication on the downstream side. The device may be a USB hub configured as described. Correspondingly, a host platform can gain the ability to communicate with audio bus peripheral devices using only the USB infrastructure already present on the platform, with all audio bus protocol management performed by the device.

Additionally, or alternatively, a host system requires a standardized mechanism to discover and configure a device of the kind as described above, without relying on proprietary detection logic or platform-specific firmware changes. In various aspects described herein, the device presents itself to the host controller as a USB device belonging to a device class assigned for audio bus communication. The device stores class-specific descriptors in a memory and provides those descriptors to the host controller through the standard USB enumeration mechanism. Correspondingly, the host controller discovers, identifies, and configures the device using the same USB enumeration process used for any other USB device class, without requiring any modification to the USB host controller software or USB enumeration logic of the host platform.

Additionally, or alternatively, different audio bus peripheral devices may implement different physical-layer configurations, and existing USB software stacks and audio bus peripheral software stacks must interoperate through the device without modification to either stack. In various aspects described herein, the processing circuitry executes a software interface that bridges between the USB software stack on the host side and the audio bus peripheral software stack on the peripheral device side, and the downstream-facing port of the device supports both single-ended and differential physical-layer signaling configurations as well as multi-drop topologies in which multiple audio bus peripheral devices share a common physical connection. Correspondingly, audio bus peripheral devices employing different physical-layer configurations can be accessible to the host system audio subsystem through the existing USB software stack, with the addition of only the software interface in the device and without modification to the USB software stack or the audio bus peripheral software stack.

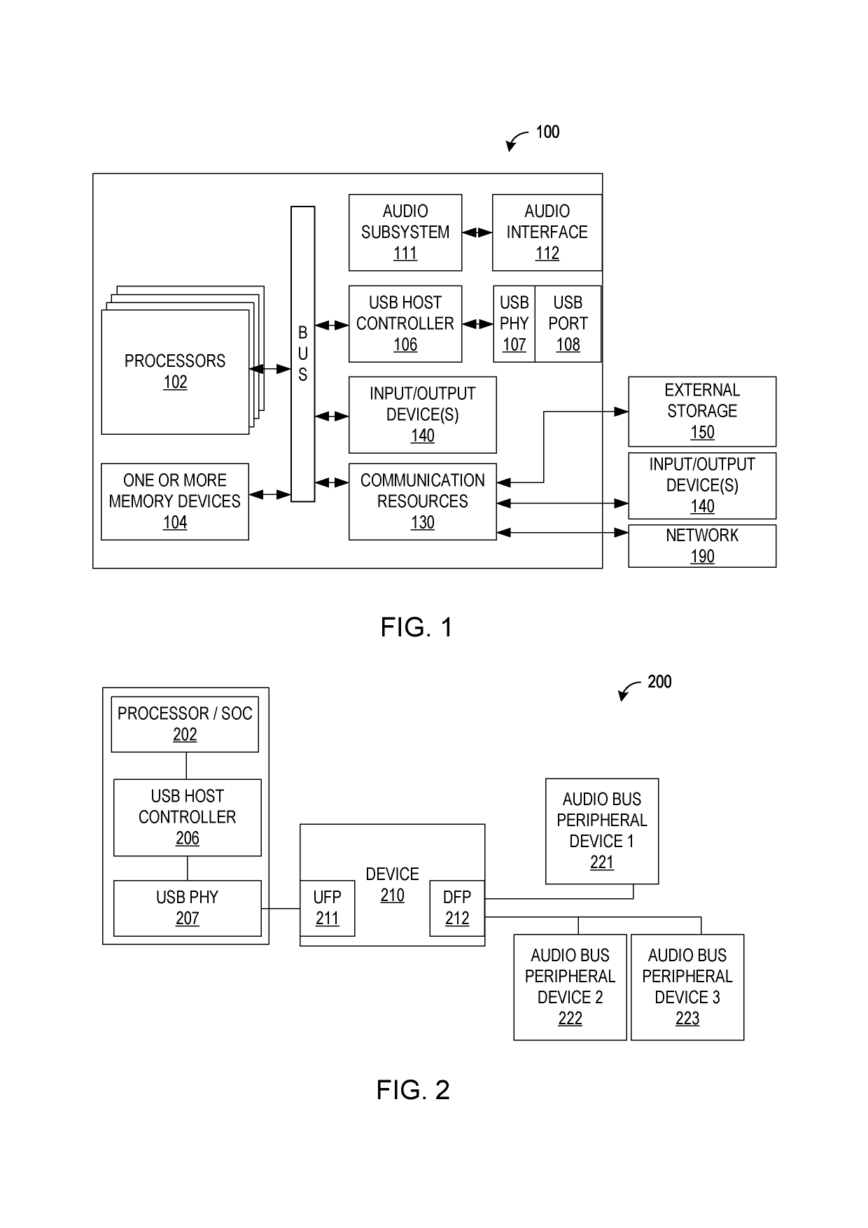

FIG. 1 illustrates a block diagram of an example computing system 100 in accordance with various aspects described herein. The computing system 100 includes a system of interconnected hardware and software resources configured to execute instructions, process data, and manage the allocation of computational capabilities. The computing system 100 may be a personal computer, a laptop computer, a tablet computer, a mobile handset, a server, or any other suitable computing platform in which a USB host controller is present and in which audio peripheral devices are to be supported.

The computing system 100 includes one or more processors 102. The one or more processors 102 represent the computational core of the computing system 100. Each processor among the one or more processors 102 executes instructions, processes data, and manages system operations. The processors 102 may include, for example, one or a combination of: a central processing unit (CPU), a reduced instruction set computing (RISC) processor, a complex instruction set computing (CISC) processor, a graphics processing unit (GPU), a DSP, an ASIC, an FPGA, a microprocessor or controller, a multi-core processor, a multithreaded processor, an ultra-low voltage processor, an embedded processor, an xPU, a data processing unit (DPU), an Infrastructure Processing Unit (IPU), a network processing unit (NPU), another processor (including any of those discussed herein), and/or any suitable combination thereof. Each processor among the one or more processors 102 may include a cache hierarchy and a memory controller interface through which the processor initiates memory transactions directed to the one or more memory devices 104. The one or more processors 102 communicate with other components of the computing system 100 via a bus.

The computing system 100 includes one or more memory devices 104 coupled to the one or more processors 102. The one or more memory devices 104 provide the main storage for data and instructions that are actively used by the one or more processors 102 during operation. The one or more memory devices 104 may include volatile memory technologies, such as dynamic random access memory or synchronous dynamic random access memory, or non-volatile memory technologies, such as static random access memory. The one or more memory devices 104 store instructions that are loaded and executed by the one or more processors 102, and store data that is read from and written to by the one or more processors 102 during the execution of those instructions.

In some examples, the one or more processors 102 may execute instructions (e.g., non-transitory computer-readable instructions). Instructions may include software, program code, application(s), applet(s), an app(s), firmware, microcode, machine code, and/or other executable code for causing at least any one of the processors 102 to perform a method. The instructions may reside, completely or partially, within at least one of the processors 102 (e.g., within the processor's cache memory), the memory devices 104, or any suitable combination thereof. Furthermore, any portion of the instructions may be transferred to the computing system 100 from any combination of the input and/or output devices 140 or the external storage 150.

The computing system 100 may include non-volatile storage coupled to the one or more processors 102 via the bus or via the input/output devices 140. The non-volatile storage provides persistent data storage that retains stored data when the computing system 100 is powered off. The non-volatile storage may include flash memory, a solid-state drive, a magnetic disk drive, or any other non-volatile storage medium. The non-volatile storage stores an operating system, device drivers, application software, configuration data, and other persistent data used by the computing system 100.

As examples, the memory devices 104 can be or can include random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, dual inline memory modules (DIMMs), microDIMMs, MiniDIMMs, block addressable memory device(s) (e.g., those based on NAND or NOR technologies (e.g., single-level cell (SLC), multi-level cell (MLC), quad-level cell (QLC), tri-level cell (TLC), or some other NAND), read-only memory (ROM), programmable ROM (PROM), erasable PROM (EPROM), electrically EPROM (EEPROM), flash memory, non-volatile RAM (NVRAM), solid-state storage, magnetic disk storage mediums, optical storage mediums, memory devices that use chalcogenide glass, multi-threshold level NAND flash memory, NOR flash memory, single or multi-level phase change memory (PCM) and/or phase change memory with a switch (PCMS), NVM devices that use chalcogenide phase change material (e.g., chalcogenide glass), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge random access memory (CB-RAM), or spin transfer torque (STT)-MRAM, a spintronic magnetic junction memory based device, a magnetic tunneling junction (MTJ) based device, a domain wall (DW) and spin orbit transfer (SOT) based device, a thyristor based memory device, and/or a combination of any of the aforementioned memory devices, and/or other memory. Each memory device 104 may be packaged individually or in a vertically stacked arrangement within a common package, and may include one or more independently addressable ranks accessible via respective chip select signals.

The computing system 100 may include a USB host controller 106 and a USB physical-layer transceiver 107 coupled to the one or more processors 102 via the bus. The USB host controller 106 is a hardware component that initiates and manages all USB communication on behalf of the computing system 100. The USB host controller 106 generates USB transactions directed to USB devices connected to the downstream side of the USB host controller 106, controls the scheduling and sequencing of USB transactions on the USB bus, and performs USB enumeration of connected USB devices by issuing control transfer requests to retrieve USB device descriptors from each connected USB device. The USB physical-layer transceiver 107 is coupled to the USB host controller 106 and handles the electrical signaling of USB communication between the USB host controller 106 and USB devices connected to the computing system 100. The USB physical-layer transceiver 107 converts the digital signals generated by the USB host controller 106 into the differential electrical signals defined by the USB specification for transmission on the USB bus, and converts received differential electrical signals back into digital signals for the USB host controller 106. The computing system 100 may further include a USB port 108 coupled to the USB physical-layer transceiver 107, through which USB devices are physically connected to the computing system 100.

The one or more processors 102, the one or more memory devices 104, the USB host controller 106, the USB physical-layer transceiver 107, the audio subsystem 111, the input/output devices 140, and the communication resources 130 of the computing system 100 are coupled to one another via a bus. The bus provides the data pathways over which the one or more processors 102 communicate with each of the other components of the computing system 100. The bus may include point-to-point interconnects, a shared parallel bus, a serial interconnect fabric, or any suitable combination thereof, depending on the architecture of the computing system 100.

The computing system 100 may include additional communication interfaces and input/output interfaces. The communication resources 130 may include one or more network interface controllers that connect the computing system 100 to a network 190. The network 190 may be a local area network, a wide area network, or the internet, through which the computing system 100 may exchange data with remote hardware resources and external storage 150. The input/output devices 140 may include display interfaces, storage controllers, human interface device controllers, and hardware accelerators coupled to the bus. The computing system 100 may further include wireless communication components, such as Wi-Fi or cellular communication modules, as part of the communication resources 130.

The computing system 100 includes an audio subsystem 111 coupled to the one or more processors 102 via the bus. The audio subsystem 111 is a hardware and software component that processes audio data for playback and capture within the computing system 100. The audio subsystem 111 generates digital audio data representing audio content for output to audio peripheral devices, and receives digital audio data captured by audio peripheral devices for processing by the one or more processors 102. The computing system 100 further includes an audio interface 112 coupled to the audio subsystem 111. The audio interface 112 provides the communication pathway through which the audio subsystem 111 exchanges audio data and control information with audio peripheral devices. The audio subsystem 111 and the audio interface 112 together provide the platform-level audio infrastructure through which the computing system 100 communicates with audio peripheral devices.

The computing system 100 includes a software stack including an operating system, device drivers, and application software executed by the one or more processors 102. The operating system manages the hardware resources of the computing system 100 and provides services to application software. The device drivers provide the software interface through which the operating system and application software communicate with specific hardware components of the computing system 100. The software stack includes a USB software stack that manages communication between the one or more processors 102 and USB devices connected to the USB host controller 106. The USB software stack includes a USB host controller driver that manages the operational behavior of the USB host controller 106, USB class drivers that implement the communication protocols associated with specific USB device classes, and higher-level software components that provide USB device services to application software running on the one or more processors 102.

The input/output devices 140 associated with the computing system 100 represent local peripheral interfaces and devices. These may include storage controllers, such as redundant array of independent disks controllers, universal serial bus controllers, and interfaces for human interaction devices like keyboards and monitors if the system is configured for direct user interaction. The input/output devices 140 may also include hardware accelerators, such as field-programmable gate arrays or application-specific integrated circuits, installed to offload specific processing tasks from the processors 102. The bus facilitates the communication between the processors 102 and the input/output devices 140, often utilizing standards like peripheral component interconnect express. FIG. 1 also illustrates input/output devices 140 external to the computing system 100, which may represent peripherals connected via the communication resources 130 or the network 190, providing flexibility in system configuration.

The external storage 150 represents persistent data storage repositories located outside the immediate physical chassis of the computing system 100. The external storage 150 may include storage area networks, network-attached storage systems, or cloud-based storage services. The external storage 150 may store application data and operating system files that are loaded into the one or more memory devices 104 during operation. The connection to the external storage 150 allows for centralized data management and facilitates features such as high availability, where a workload can be restarted on different hardware resources if the primary hardware fails. Access to the external storage 150 is mediated by the communication resources 130 and the protocols of the network 190, such as internet small computer systems interface or non-volatile memory express over fabrics.

The computing system 100 illustrated in FIG. 1 represents an example computing environment in which the embodiments described hereinafter may be implemented. The specific configuration of the computing system 100 shown in FIG. 1 is illustrative and not limiting. The embodiments described hereinafter may be implemented in any computing system that includes a USB host controller, a USB physical-layer transceiver, and an audio subsystem, regardless of the specific processor architecture, memory configuration, or additional interfaces present in the computing system.

FIG. 2 illustrates an example block diagram of system 200 including a host device and one or more audio bus peripheral devices, with a device 210 interposed between the host device and the one or more audio bus peripheral devices. The system 200 represents the high-level deployment context of the device 210 as described herein. In the system 200, the host device can communicate with the one or more audio bus peripheral devices. In some examples, the communication is facilitated exclusively through the device 210, without any direct communication path between the host device and the one or more audio bus peripheral devices.

The host device of the system 200 includes a processor or system-on-chip 202, a USB host controller 206 coupled to the processor or system-on-chip 202, and a USB physical-layer transceiver 207 coupled to the USB host controller 206. In an example, the host device may be a computing system (e.g., the computing system 100). The processor or system-on-chip 202 may be the central processing element of the host device. The processor or system-on-chip 202 may execute the software stack that manages communication with USB devices connected to the USB host controller 206. The USB host controller 206 may be a hardware component that initiates and manages all USB communication on behalf of the host device. The USB host controller 206 generates USB transactions directed to USB devices connected to the downstream side of the USB host controller 206, including the device 210. The USB physical-layer transceiver 207 is coupled to the USB host controller 206 and handles the physical-layer electrical signaling of USB communication between the USB host controller 206 and the device 210. The USB physical-layer transceiver 207 converts digital signals generated by the USB host controller 206 into differential electrical signals conforming to the USB specification for transmission to the device 210, and converts differential electrical signals received from the device 210 into digital signals for the USB host controller 206.

The device 210 may be coupled to the host device on the upstream side and to the one or more audio bus peripheral devices on the downstream side. The device 210 includes an upstream-facing port 211 and at least one downstream-facing port 212. The upstream-facing port 211 is the port of the device 210 that is connected to the host controller side of the USB communication topology, through which the device 210 receives USB transactions from, and transmits USB transactions to, the USB host controller 206 via the USB physical-layer transceiver 207. The downstream-facing port 212 is the port of the device 210 that is connected to the peripheral device side of the topology, through which the device 210 communicates with the one or more audio bus peripheral devices via an audio bus protocol. The device 210 can bridge between USB communication received through the upstream-facing port 211 and audio bus protocol communication transmitted and received through the downstream-facing port 212.

The system 200 includes audio bus peripheral device 1221, audio bus peripheral device 2222, and audio bus peripheral device 3223, each connected to the downstream-facing port 212 of the device 210. The audio bus peripheral device 1221 is connected to the downstream-facing port 212 via a dedicated physical connection. The audio bus peripheral device 2222 and the audio bus peripheral device 3223 are each connected to the downstream-facing port 212 via a shared physical connection, illustrating a multi-drop configuration in which a plurality of audio bus peripheral devices share a common physical connection to the downstream-facing port 212. Each of the audio bus peripheral device 1221, the audio bus peripheral device 2222, and the audio bus peripheral device 3223 communicates with the device 210 exclusively via an audio bus protocol. The audio bus peripheral device 1221, the audio bus peripheral device 2222, and the audio bus peripheral device 3223 do not implement a USB device controller and do not communicate with the host device via the USB protocol. Examples of audio bus peripheral devices that may be deployed as the audio bus peripheral device 1221, the audio bus peripheral device 2222, or the audio bus peripheral device 3223 include audio codecs, digital microphone assemblies, audio amplifiers, and speaker drivers.

The USB connection between the USB physical-layer transceiver 207 of the host device and the upstream-facing port 211 of the device 210 may be a USB 2.0 connection or an embedded USB 2.0 connection. In an example in which the USB connection is a USB 2.0 connection, the USB physical-layer transceiver 207 and the upstream-facing port 211 communicate via full-swing differential signaling on D+ and D− signal lines at USB 2.0 voltage levels. In an example in which the USB connection is an embedded USB 2.0 connection, the USB physical-layer transceiver 207 and the upstream-facing port 211 communicate via reduced-voltage chip-to-chip signaling conforming to the eUSB2 specification, maintaining USB 2.0 protocol compatibility while operating at lower signaling voltages. In both examples, the processor or system-on-chip 202, the USB host controller 206, and the USB physical-layer transceiver 207 of the host device require no modification to support communication with the audio bus peripheral device 1221, the audio bus peripheral device 2222, and the audio bus peripheral device 3223 through the device 210.

From the perspective of the processor or system-on-chip 202 and the USB host controller 206, the device 210 presents itself as a USB device connected to the downstream side of the USB host controller 206. The USB host controller 206 discovers and configures the device 210 through the standard USB enumeration process, during which the USB host controller 206 issues control transfer requests through the upstream-facing port 211 to retrieve USB device descriptors from the device 210. In some embodiments, the device 210 is associated with a device class assigned for audio bus communication, and the USB device descriptors provided by the device 210 to the USB host controller 206 during USB enumeration include a device class code, a device subclass code, and a device protocol code that identify the device 210 as a USB device for audio bus communication. The USB host controller 206 uses the device class information retrieved during USB enumeration to load the appropriate class driver for the device 210 on the processor or system-on-chip 202.

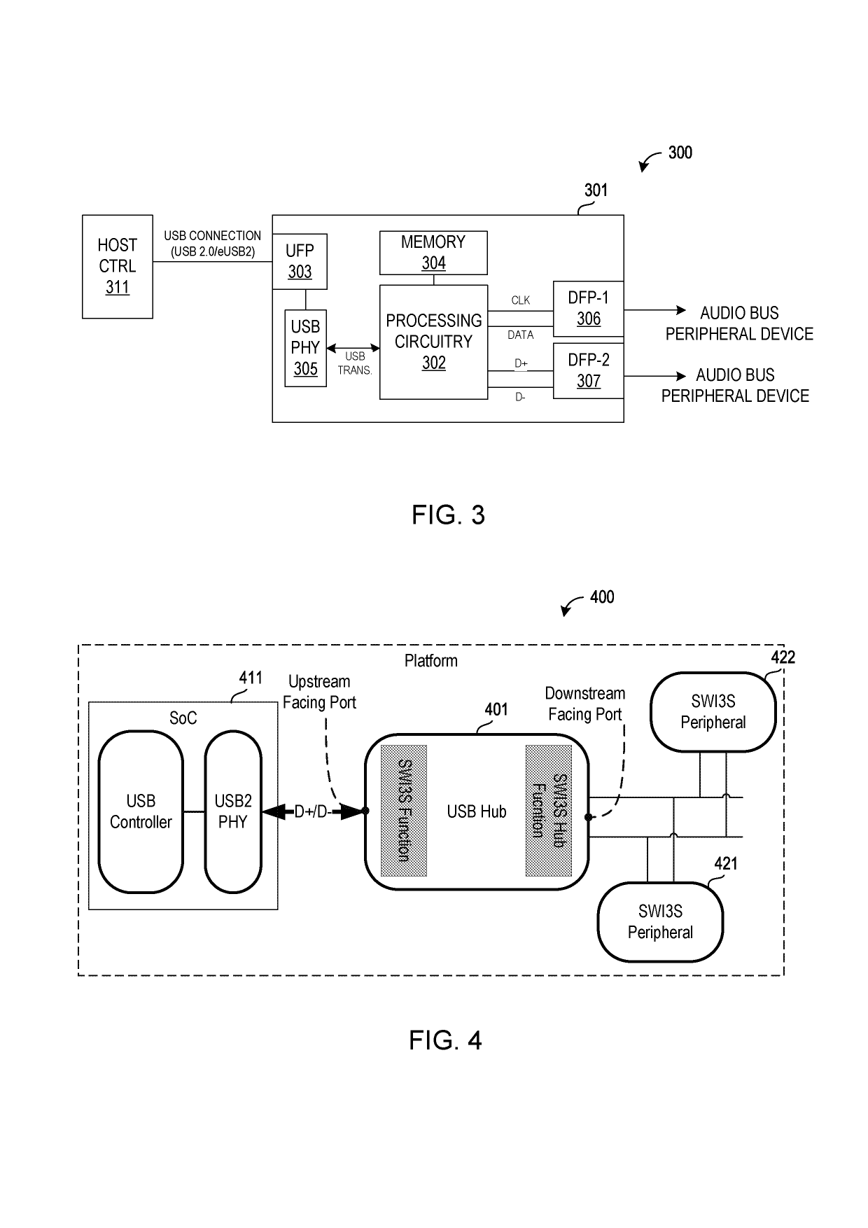

FIG. 3 illustrates an example block diagram of a device 301 in accordance with various aspects described herein. The device 301 may be implemented as a hub device. The device 301 described herein may correspond to the device 210. The device 301 includes an upstream-facing port 303, a USB physical-layer transceiver 305, processing circuitry 302, a memory 304, and at least one of a first downstream-facing port DFP-1 306 and/or a second downstream-facing port DFP-2 307. The upstream-facing port 303 may be connected to the host controller side of the USB communication topology. The first downstream-facing port DFP-1 306 and the second downstream-facing port DFP-2 307 may be each connected to the peripheral device side of the topology. The host controller 311 may be coupled to the upstream-facing port 303 via a USB connection that may be a USB 2.0 connection or an embedded USB 2.0 connection.

The upstream-facing port 303 is the port of the device 301 that is connected to the host controller side of the USB communication topology. The upstream-facing port 303 is configured to communicate with the host controller 311 via USB signaling. USB transactions carrying audio bus data as payload are received by the device 301 through the upstream-facing port 303, and USB transactions carrying audio bus data as payload are transmitted by the device 301 to the host controller 311 through the upstream-facing port 303. The upstream-facing port 303 may provide the sole communication interface between the device 301 and the host controller 311 for the exchange of audio bus data.

The USB physical-layer transceiver 305 may be coupled to the upstream-facing port 303 and to the processing circuitry 302. The USB physical-layer transceiver 305 handles the physical-layer electrical signaling of USB communication between the device 301 and the host controller 311. The USB physical-layer transceiver 305 converts digital USB transmission signals generated by the processing circuitry 302 into differential electrical signals conforming to the USB specification for transmission to the host controller 311 through the upstream-facing port 303. The USB physical-layer transceiver 305 further converts differential electrical signals received from the host controller 311 through the upstream-facing port 303 into digital signals for processing by the processing circuitry 302. The USB physical-layer transceiver 305 facilitates an exchange of USB transactions.

The device 301 includes at least one downstream-facing port configured to communicate with one or more audio bus peripheral devices via an audio bus protocol. As shown in FIG. 3, the device 301 includes a first downstream-facing port DFP-1 306 and a second downstream-facing port DFP-2 307, each connected to a respective audio bus peripheral device. The first downstream-facing port DFP-1 306 and the second downstream-facing port DFP-2 307 each carry audio bus protocol communication between the processing circuitry 302 and the respective audio bus peripheral devices connected to those ports. The signal lines of the first downstream-facing port DFP-1 306 and the second downstream-facing port DFP-2 307 may be configured for different physical-layer signaling modes.

In an example, the first downstream-facing port DFP-1 306 is configured for single-ended signaling. As shown in FIG. 3, the first downstream-facing port DFP-1 306 includes a clock line CLK and a data line DATA. The clock line CLK carries a clock signal from the processing circuitry 302 to the audio bus peripheral device connected to the first downstream-facing port DFP-1 306 as a single-ended signal. The data line DATA carries a data signal as a single-ended signal, with the data signal being both transmitted from the processing circuitry 302 to the audio bus peripheral device and received by the processing circuitry 302 from the audio bus peripheral device on the same data line DATA. The clock signal on the clock line CLK provides timing information to the audio bus peripheral device for data recovery and audio sample clock generation.

In an example, the second downstream-facing port DFP-2 307 is configured for differential signaling. As shown in FIG. 3, the second downstream-facing port DFP-2307 includes a differential pair of lines D+ and D−. Audio bus data is transmitted from the processing circuitry 302 to the audio bus peripheral device connected to the second downstream-facing port DFP-2 307 as a differential signal across the D+ and D− lines. Audio bus data is received by the processing circuitry 302 from the audio bus peripheral device connected to the second downstream-facing port DFP-2 307 as a differential signal across the D+ and D− lines. The differential signaling of the second downstream-facing port DFP-2 307 provides improved electromagnetic compatibility performance relative to single-ended signaling and is suited to system designs in which signal integrity, electromagnetic interference, or cable length constraints favor differential physical-layer operation.

The first downstream-facing port DFP-1 306 and the second downstream-facing port DFP-2 307 may each operate in a half-duplex mode on their respective shared physical connections. Transmission of audio bus data from the processing circuitry 302 of the device 301 to the audio bus peripheral device connected to the first downstream-facing port DFP-1 306 and reception of audio bus data from that audio bus peripheral device to the processing circuitry 302 may occur alternately on the shared data line DATA of the first downstream-facing port DFP-1 306. Similarly, transmission of audio bus data from the processing circuitry 302 to the audio bus peripheral device connected to the second downstream-facing port DFP-2 307 and reception of audio bus data from that audio bus peripheral device to the processing circuitry 302 occur alternately on the shared differential pair D+ and D− of the second downstream-facing port DFP-2 307. The processing circuitry 302 coordinates the alternating transmission and reception on each shared physical connection, ensuring that only one device drives the shared physical connection at any given time.

The processing circuitry 302 may be coupled to the upstream-facing port 303, the USB physical-layer transceiver 305, the memory 304, the first downstream-facing port DFP-1 306, and the second downstream-facing port DFP-2 307. The processing circuitry 302 may be configured to process first audio bus data received via USB transactions through the upstream-facing port 303. The processing circuitry 302 may further cause the first audio bus data to be forwarded to the one or more audio bus peripheral devices via the audio bus protocol through the first downstream-facing port DFP-1 306 or the second downstream-facing port DFP-2 307. The processing circuitry 302 may be further configured to process second audio bus data received from the one or more audio bus peripheral devices via the audio bus protocol through the first downstream-facing port DFP-1 306 or the second downstream-facing port DFP-2 307. The processing circuitry 302 may further cause the second audio bus data to be forwarded to the host controller 311 via USB transactions through the upstream-facing port 303.

The processing circuitry 302 may be implemented as a microcontroller, a digital signal processor, an application-specific integrated circuit, a field-programmable gate array, or any other hardware logic element capable of executing the bridging functions described herein. In some examples, the processing circuitry 302 includes a combination of programmable logic and dedicated hardware logic elements. In an example, the processing circuitry 302 is implemented as a microcontroller that executes firmware stored in the memory 304, with dedicated hardware logic elements providing the physical-layer interface logic for the first downstream-facing port DFP-1 306 and the second downstream-facing port DFP-2 307. The processing circuitry 302 may be configured to operate simultaneously as a USB device on the upstream side, which may involve responding to USB transactions initiated by the host controller 311 through the upstream-facing port 303. The processing circuitry 302 may further be configured to operate as an audio bus manager on the downstream side, which may involve initiating and managing audio bus protocol communication with the audio bus peripheral devices through the first downstream-facing port DFP-1 306 and the second downstream-facing port DFP-2 307.

The processing circuitry 302 may be configured to process first audio bus data received via USB transactions through the upstream-facing port 303. Processing first audio bus data received via USB transactions may include receiving, through the upstream-facing port 303 and the USB physical-layer transceiver 305, one or more USB transactions initiated by the host controller 311. Processing first audio bus data received via USB transactions may include identifying the transaction type, the target endpoint address, and the transfer direction from the token packet of each received USB transaction. Moreover, the processing of the first audio bus data may include extracting the audio bus data payload from the data packet of each received USB transaction. In some aspects, the processing of the first audio bus data may include determining, from the extracted audio bus data payload, the audio bus peripheral device address, the type of audio bus data, and the content of the audio bus data to be forwarded.

In an example, the processing circuitry 302 receives a USB bulk transfer transaction through the upstream-facing port 303, extracts an audio bus data payload from the data packet of the USB bulk transfer transaction, and identifies from the audio bus data payload that the extracted data includes a register write command addressed to a specific audio bus peripheral device connected to the first downstream-facing port DFP-1 306.

The processing circuitry 302 may be configured to cause the first audio bus data to be forwarded via the audio bus protocol, which may involve converting the extracted audio bus data payload from the USB data format into the audio bus data format conforming to the audio bus protocol. The causing the first audio bus data to be forwarded via the audio bus protocol may include generating the audio bus protocol frame structure that encodes the converted audio bus data in accordance with the framing, addressing, and scheduling conventions of the audio bus protocol. In some examples, the processing circuitry 302 may determine the physical connection of the downstream-facing port through which the addressed audio bus peripheral device is reachable and additionally, or alternatively, drive the signal lines of that downstream-facing port with the audio bus protocol frame in accordance with the physical-layer signaling mode of that downstream-facing port.

In an example, the processing circuitry 302 converts a register write command extracted from a USB transaction payload into an audio bus protocol control frame addressed to the audio bus peripheral device connected to the first downstream-facing port DFP-1 306, and drives the data line DATA of the first downstream-facing port DFP-1 306 with the audio bus protocol control frame as a single-ended signal in synchronization with the clock signal driven on the clock line CLK.

The processing circuitry 302 may be configured to process second audio bus data received from the one or more audio bus peripheral devices via the audio bus protocol, in which the processing circuitry 302 may receive, through the signal lines of the first downstream-facing port DFP-1 306 or the second downstream-facing port DFP-2 307, one or more audio bus protocol frames transmitted by an audio bus peripheral device during a reception interval on the shared physical connection. Moreover, the processing circuitry 302 may parse the received audio bus protocol frames in accordance with the framing and encoding conventions of the audio bus protocol to extract the audio bus data payload and identify the source audio bus peripheral device address. The processing circuitry 302 may further determine, from the extracted audio bus data payload, the type of audio bus data received, which may include audio payload data such as pulse-code modulation audio samples, or control data such as status register values or interrupt notifications.

In an example, the processing circuitry 302 receives a sequence of audio bus protocol frames from an audio bus peripheral device connected to the second downstream-facing port DFP-2 307 as a differential signal on the D+ and D− lines, parses the received frames to extract digitized audio samples representing audio content captured by the audio bus peripheral device, and buffers the extracted audio samples for encapsulation into USB transactions.

The processing circuitry 302 is configured to cause the second audio bus data to be forwarded to the host controller 311 via USB transactions through the upstream-facing port 303. Causing the second audio bus data to be forwarded via USB transactions may include converting the second audio bus data from the audio bus data format into the USB data format conforming to the USB specification. The processing circuitry 302 may construct a USB transaction including a token packet that identifies the transaction type and the target endpoint within the device 301, a data packet whose payload includes the converted second audio bus data, and a handshake packet exchanged with the host controller 311 to confirm successful data transfer. Further, causing the second audio bus data to be forwarded via USB transactions may include driving the USB physical-layer transceiver 305 to transmit the USB transaction to the host controller 311 through the upstream-facing port 303.

In an example, the processing circuitry 302 converts digitized audio samples extracted from audio bus protocol frames received from an audio bus peripheral device connected to the second downstream-facing port DFP-2 307 into a USB isochronous transfer payload, constructs a USB isochronous transfer transaction with the converted audio samples as the data packet payload, and transmits the USB isochronous transfer transaction to the host controller 311 through the upstream-facing port 303 via the USB physical-layer transceiver 305.

The processing circuitry 302 may achieve the bridging function of the device 301 by implementing and maintaining concurrent operation of two distinct protocol engines, which includes a USB device protocol engine on the upstream side and an audio bus manager protocol engine on the downstream side. The USB device protocol engine may manage the USB transaction layer on the upstream-facing port 303, handling USB enumeration, USB endpoint management, USB transfer scheduling, and USB error recovery in accordance with the USB specification. The audio bus manager protocol engine manages the audio bus protocol layer on the first downstream-facing port DFP-1 306 and the second downstream-facing port DFP-2 307, handling audio bus frame generation, audio bus device addressing, audio bus timing and clock management, and audio bus error recovery in accordance with the audio bus protocol. The processing circuitry 302 may transfer audio bus data between the USB device protocol engine and the audio bus manager protocol engine through an internal data path, in which the processing circuitry 302 performs the data format conversion described herein to ensure that audio bus data received as USB transaction payload on the upstream side is correctly reformatted and forwarded as audio bus protocol frames on the downstream side, and vice versa.

The memory 304 is coupled to the processing circuitry 302. The memory 304 may store one or more class-specific descriptors indicating the capabilities of the device 301 for audio bus communication. The processing circuitry 302 may be configured to provide the one or more class-specific descriptors stored in the memory 304 to the host controller 311 in response to USB descriptor requests received through the upstream-facing port 303 during USB enumeration. In an example, the memory 304 stores a device descriptor, a configuration descriptor, an interface descriptor, endpoint descriptors, and one or more class-specific descriptors for the device 301. During USB enumeration, the host controller 311 can issue a series of USB control transfer requests to the default control endpoint of the device 301 through the upstream-facing port 303. The processing circuitry 302 receives each USB control transfer request through the upstream-facing port 303, and may retrieve the requested descriptor from the memory 304 and return the requested descriptor to the host controller 311 as the data packet payload of the USB control transfer response through the upstream-facing port 303.

The audio bus data communicated through the device 301 may include audio payload data and control data. Audio payload data communicated through the device 301 includes digitized audio content, such as pulse-code modulation audio samples representing audio waveforms for playback by an audio bus peripheral device or captured by an audio bus peripheral device for transmission to the host controller 311. Control data communicated through the device 301 includes configuration commands, register read operations, register write operations, and status responses exchanged between the processing circuitry 302 and the audio bus peripheral devices connected to the first downstream-facing port DFP-1 306 and the second downstream-facing port DFP-2 307.

In an example, the processing circuitry 302 receives a USB transaction from the host controller 311 through the upstream-facing port 303 whose payload includes a register write command addressed to an audio bus peripheral device, extracts the register write command from the USB transaction payload, formats the register write command as an audio bus protocol control frame, and drives the control frame on the signal lines of the appropriate downstream-facing port to configure the addressed audio bus peripheral device.

The processing circuitry 302 may be configured to translate between a USB data format received through the upstream-facing port 303 and an audio bus data format transmitted through the first downstream-facing port DFP-1 306 or the second downstream-facing port DFP-2 307, and vice versa. The USB data format is the format of the data packet payload of USB transactions, which conforms to the USB specification in terms of packet structure, endpoint type, and transfer type. The audio bus data format is the format of the serial bitstream transmitted on the signal lines of the first downstream-facing port DFP-1 306 or the second downstream-facing port DFP-2 307, which conforms to the audio bus protocol in terms of frame structure, bit encoding, and data field layout. The translation performed by the processing circuitry 302 can extract audio bus data payload from USB transaction data packets and reformat the extracted audio bus data payload into audio bus protocol frames for transmission through the downstream-facing port, and can conversely extract audio bus data from received audio bus protocol frames and encapsulate the extracted audio bus data as the payload of USB transaction data packets for transmission through the upstream-facing port 303.

The processing circuitry 302 may be configured to communicate audio bus data to and from the host controller 311 exclusively via USB transactions conforming to the USB specification through the upstream-facing port 303. No communication path other than the upstream-facing port 303 and the USB physical-layer transceiver 305 may exist between the device 301 and the host controller 311 for the exchange of audio bus data. In an example, the device 301 does not provide a non-USB communication interface to the host controller 311. All audio bus data originating from the host controller 311 and destined for the audio bus peripheral devices connected to the first downstream-facing port DFP-1 306 or the second downstream-facing port DFP-2 307 enters the device 301 exclusively as the payload of USB transactions received through the upstream-facing port 303. All audio bus data originating from the audio bus peripheral devices and destined for the host controller 311 exits the device 301 exclusively as the payload of USB transactions transmitted through the upstream-facing port 303 to the host controller 311.

FIG. 4 illustrates an example system 400 including a device in accordance with various aspects described herein. The device 401 is deployed on a computing platform and communicates with a host system-on-chip via a native USB 2.0 connection. For example, the device 401 may correspond to the device 301 deployed in the computing system 100. The system 400 represents a specific implementation of the device 401 within a platform (e.g. the computing system 100) in which the USB host controller and USB physical-layer transceiver of the host system-on-chip are connected to the upstream-facing port of the device 401 via D+/D− differential signaling at native USB 2.0 voltage levels. The system 400 shows the device 401 positioned between the host system-on-chip on the upstream side and SWI3S peripheral devices 421 and 422 on the downstream side, where all may reside within the boundaries of the platform.

The host side of the system 400 includes a system-on-chip (e.g., the processor / SOC 202) that integrates a USB controller (e.g., the USB host controller 206) and a USB2 PHY (e.g., the USB PHY 207). The USB controller is the hardware component within the system-on-chip that initiates and manages all USB communication on behalf of the host processor. The USB2 PHY is the USB physical-layer transceiver within the system-on-chip that handles the physical-layer electrical signaling of the USB connection between the system-on-chip and the upstream-facing port of the device 401. The USB2 PHY may convert digital signals generated by the USB controller into D+/D− differential electrical signals conforming to the USB 2.0 specification at native USB 2.0 voltage levels, and convert D+/D− differential electrical signals received from the device 401 into digital signals for the USB controller. The USB connection between the USB2 PHY and the upstream-facing port of the device 401 is a native USB 2.0 connection, as indicated by the D+/D− signal lines shown between the system-on-chip and the device 401 in FIG. 4.

The device 401 may be a USB hub that includes a SWI3S Function and a SWI3S Hub Function. The upstream-facing port of the device 401 may be connected to the host controller side of the USB communication topology and receives the native USB 2.0 connection from the USB2 PHY of the system-on-chip. The USB physical-layer transceiver of the device 401 may be configured for native USB 2.0 signaling on the upstream side, handling the electrical signaling of the D+/D− connection between the USB2 PHY of the system-on-chip and the upstream-facing port of the device 401 in accordance with the USB 2.0 specification. The SWI3S Function may be implemented, by the processor of the device 401 (e.g. the processing circuitry 302), as an interface to the upstream-facing port of the device 401. The SWI3S Function provides the interface between the USB controller of the system-on-chip and the SWI3S software stack. The SWI3S Hub Function is implemented by the processor of the device, as an interface to the downstream-facing port of the device 401. The SWI3S Hub Function provides the interface between the processing circuitry of the device 401 and the SWI3S peripheral devices 421 and 422 connected on the downstream side.

The downstream side of the system 400 includes SWI3S peripheral device 421 and SWI3S peripheral device 422, each connected to the downstream-facing port of the device 401 via the SWI3S audio bus protocol. As shown in FIG. 4, the SWI3S peripheral device 421 and the SWI3S peripheral device 422 are each connected to the downstream-facing port of the device 401 via respective physical connections. The downstream-facing port of the device 401 communicates with the SWI3S peripheral device 421 and the SWI3S peripheral device 422 via SWI3S audio bus protocol frames carried on signal lines configured for single-ended or differential physical-layer signaling, as described herein. The processing circuitry of the device 401 may be configured to manage SWI3S audio bus protocol communication with the SWI3S peripheral device 421 and the SWI3S peripheral device 422 through the downstream-facing port, acting as the SWI3S manager entity on the audio bus.

In the system 400, the system-on-chip requires no further SWI3S controller intellectual property and no audio bus controller of any kind. The USB controller and the USB2 PHY already present within the system-on-chip can be sufficient to support communication with the SWI3S peripheral device 421 and the SWI3S peripheral device 422 through the device 401. The device 401 assumes full responsibility for all SWI3S audio bus protocol management on the downstream side, including SWI3S frame generation, SWI3S device addressing, SWI3S clock management, and SWI3S error recovery. The system-on-chip exchanges audio bus data with the SWI3S peripheral device 421 and the SWI3S peripheral device 422 exclusively via USB transactions conforming to the USB 2.0 specification directed to the device 401 through the native USB 2.0 connection, without any modification to the USB controller, the USB2 PHY, or the USB software stack of the system-on-chip.

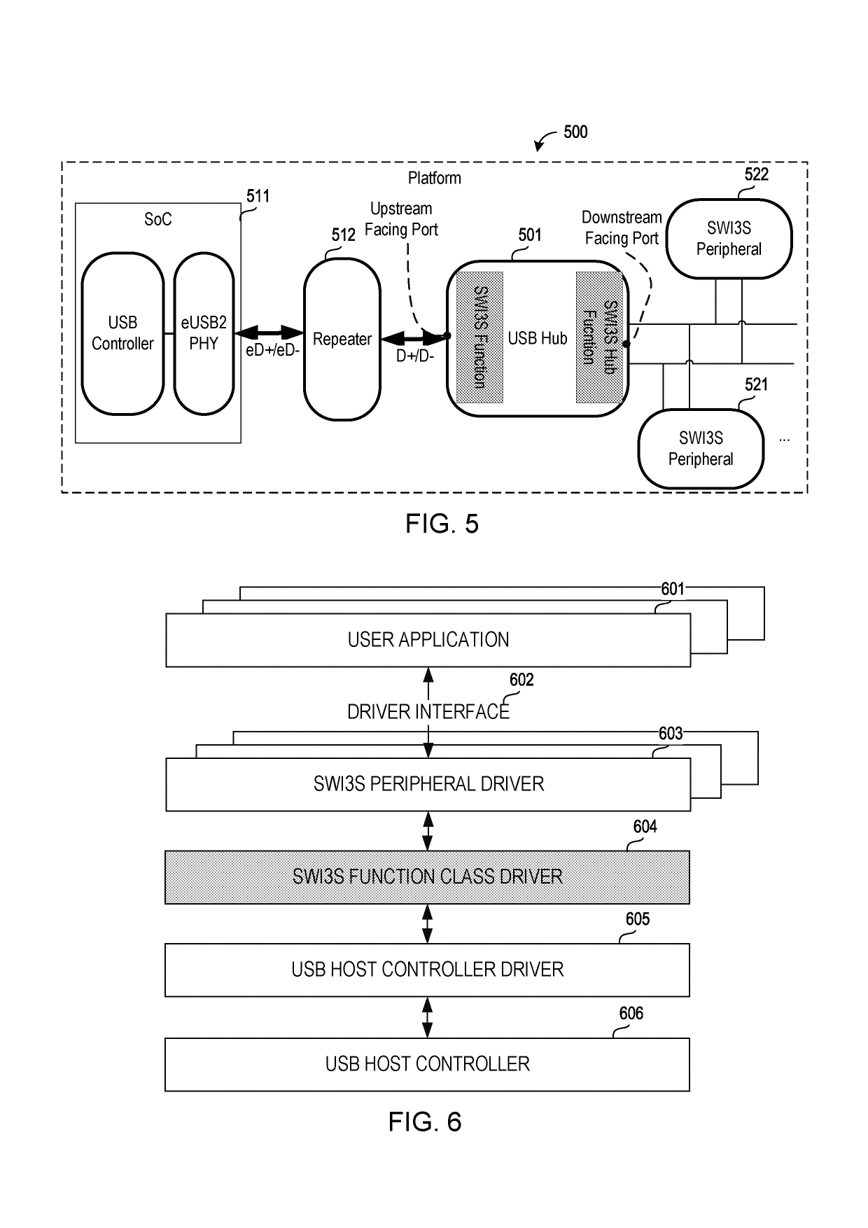

FIG. 5 illustrates an example system 500 including a device in accordance with various aspects described herein. The system 500 includes a device 501 deployed on a computing platform (e.g. the computing system 100) and communicates with a host system-on-chip (the processor / SOC 202) via an embedded USB 2.0 connection. The system 500 of FIG. 5 is structurally equivalent to the system topology 400 of FIG. 4 with respect to the device 501 (e.g. the device 301), the downstream-facing port of the device 501, and the SWI3S peripheral devices 521 and 522. The system 500 of FIG. 5 differs from the system topology 400 of FIG. 4 solely in the physical-layer signaling characteristics of the USB connection between the system-on-chip 511 and the upstream-facing port of the device 501, which in the system 500 is an embedded USB 2.0 connection established via a repeater 512.

The system-on-chip 511 in the system 500 integrates a USB controller and an eUSB2 PHY. The eUSB2 PHY is a USB physical-layer transceiver within the system-on-chip 511 that is designed for chip-to-chip communication within a computing platform, operating at reduced signaling voltage levels relative to the native USB 2.0 voltage levels used in the system topology 400 of FIG. 4. The eUSB2 PHY transmits and receives eD+/eD− differential signals at the reduced voltage levels defined by the eUSB2 specification. A repeater 512 may be interposed between the eUSB2 PHY of the system-on-chip 511 and the upstream-facing port of the device 501. The repeater 512 converts the reduced-voltage eD+/eD− signaling received from the eUSB2 PHY of the system-on-chip 511 into standard USB 2.0 D+/D− signaling at native USB 2.0 voltage levels for transmission to the upstream-facing port of the device 501, and performs the corresponding conversion in the opposite direction for signals received from the upstream-facing port of the device 501. The eUSB2 connection maintains full USB 2.0 protocol compatibility throughout the signal path from the USB controller of the system-on-chip 511 to the upstream-facing port of the device 501, with the repeater 512 performing only physical-layer voltage conversion without modifying the USB 2.0 protocol behavior of the connection.

From the perspective of the processing circuitry of the device 501, the USB connection arriving at the upstream-facing port in the system 500 is indistinguishable in protocol terms from the native USB 2.0 connection arriving at the upstream-facing port in the system topology 400 of FIG. 4. The processing circuitry of the device 501 performs the same bridging function in the system 500 as in the system topology 400 of FIG. 4. The SWI3S Function implemented by the processing circuitry of the device 501 provides the same interface between the USB controller of the system-on-chip 511 and the USB software stack in the system 500 as in the system topology 400. The SWI3S Hub Function implemented by the processing circuitry of the device 501 provides the same interface between the processing circuitry and the downstream-facing port of the device 501 in the system 500 as in the system topology 400. The upstream-facing port of the device 501 receives D+/D− differential signals at native USB 2.0 voltage levels from the repeater 512 in the system 500, and the USB physical-layer transceiver of the device 501 operates identically in both topologies.

The choice between a native USB 2.0 connection as in the system topology 400 of FIG. 4 and an embedded USB 2.0 connection with a repeater 512 as in the system 500 of FIG. 5 can be a platform design decision determined by the physical-layer constraints of the computing platform, including the signaling voltage requirements of the system-on-chip 511, the trace length between the system-on-chip 511 and the device 501, and the power consumption requirements of the platform. The choice between the native USB 2.0 connection and the embedded USB 2.0 connection does not affect the audio bus protocol communication performed by the processing circuitry of the device 501 through the downstream-facing port. The SWI3S Hub Function implemented by the processing circuitry of the device 501 manages SWI3S audio bus protocol communication with the SWI3S peripheral device 521 and the SWI3S peripheral device 522 through the downstream-facing port identically in both system topologies, regardless of whether the upstream connection is a native USB 2.0 connection or an embedded USB 2.0 connection.

FIG. 6 illustrates an example of a software stack architecture in accordance with various aspects described herein. The software stack architecture 600 is for communication between the host device and audio bus peripheral devices through the device 301 described with reference to FIG. 3. The software stack architecture 600 shows a layered arrangement of software components that run on the processor or system-on-chip 202 described with reference to FIG. 2, through which audio bus data and control information flow between a user application 601 at the top of the stack and the USB host controller 606 at the bottom of the stack. The USB host controller 606 may correspond to the USB host controller 206 described with reference to FIG. 2. In an example, the software stack architecture 600 represents the host-side software pathway through which the processor or system-on-chip 202 communicates with the device 301 via USB transactions, and through which audio bus peripheral devices connected to the downstream-facing port of the device 301 are made accessible to the processor or system-on-chip 202.

The USB host controller driver 605 and the USB host controller 606 may together constitute the lower portion of the software stack architecture 600 and are existing, unmodified components of the host platform. The USB host controller 606 is the hardware component that initiates and manages all USB transactions on the USB bus, corresponding to the USB host controller 206 described with reference to FIG. 2. The USB host controller driver 605 may be the software component running on the processor or system-on-chip 202 that manages the operational behavior of the USB host controller 206 by writing to and reading from the memory-mapped registers of the USB host controller 206 to schedule USB transactions, retrieve USB transaction results, and handle USB bus events. The USB host controller driver 605 and the USB host controller 206 may operate identically regardless of whether the USB device connected to the downstream side of the USB host controller 206 is a conventional USB device or the device 301.

The SWI3S peripheral driver 603 is a software component running on the processor or system-on-chip 202. The SWI3S peripheral driver 603 may manage audio bus peripheral devices from the host side. In standard USB architecture, drivers that manage the functionality of connected devices run on the host processor. Accordingly, the SWI3S peripheral driver 603 may run on the processor or system-on-chip 202 and manage the audio bus peripheral device 1221, the audio bus peripheral device 2222, and the audio bus peripheral device 3223 described with reference to FIG. 2 from the host side. The management may include generating audio bus peripheral commands and audio bus data directed to those devices, and receiving audio bus data and status information returned from those devices.

The SWI3S peripheral driver 603 communicates with the next layer in the software stack architecture 600 through the driver interface 602. The SWI3S peripheral driver 603 may not be aware that the audio bus peripheral devices it manages are connected via USB through the device 301. The user application 601 may be coupled to the SWI3S peripheral driver 603 through the driver interface 602 and may be configured to consume or generate audio data by invoking the services of the SWI3S peripheral driver 603.

The SWI3S Function Class Driver 604 may be a host-side USB class driver that runs on the processor or system-on-chip 202. The SWI3S Function Class Driver 604 is positioned in the software stack architecture 600 between the USB host controller driver 605 below and the SWI3S peripheral driver 603 above. The SWI3S Function Class Driver 604 may be loaded by the USB host controller driver 605 when the USB host controller 206 enumerates the device 301 and identifies the device 301 as belonging to the USB device class assigned for audio bus communication, as described herein. Once loaded, the SWI3S Function Class Driver 604 may present an audio bus peripheral interface upward to the SWI3S peripheral driver 603 through the driver interface 602, making the audio bus peripheral devices connected to the downstream-facing port of the device 301 accessible to the SWI3S peripheral driver 603 as though the audio bus peripheral devices were directly managed audio bus devices.

The SWI3S Function Class Driver 604 may simultaneously communicate downward with the USB host controller driver 605 by encapsulating audio bus commands and audio bus data received from the SWI3S peripheral driver 603 as the payload of USB transactions directed to the device 301, and by extracting audio bus data from USB transaction payloads received from the device 301 and presenting the extracted audio bus data upward to the SWI3S peripheral driver 603. The processing circuitry 302 of the device 301 may execute internal firmware that performs the corresponding device-side translation between USB transactions received through the upstream-facing port 303 and audio bus protocol frames transmitted and received through the first downstream-facing port DFP-1 306 and the second downstream-facing port DFP-2 307.

The USB host controller 206 may recognize the device 301 as a USB device having a device class assigned for audio bus communication. During USB enumeration, the USB host controller 206 may issue USB control transfer requests through the upstream-facing port 303 of the device 301 to retrieve USB device descriptors from the device 301. The device 301 may respond to each USB control transfer request by returning the requested descriptor from the memory 304 of the device 301 through the upstream-facing port 303.

The USB device descriptors returned by the device 301 may include a device class code, a device subclass code, and a device protocol code. The device class code identifies the device 301 as belonging to the device class assigned for audio bus communication. The device subclass code identifies the specific category of audio bus communication supported by the device 301 within the assigned device class. The device protocol code identifies the specific protocol variant implemented by the device 301 within the assigned device class and subclass. The USB host controller 206 may use the device class code, the device subclass code, and the device protocol code retrieved during USB enumeration to identify and load the SWI3S Function Class Driver 604 on the processor or system-on-chip 202.

In addition to the standard USB device descriptors, the device 301 may provide one or more class-specific descriptors to the USB host controller 206 during USB enumeration. The one or more class-specific descriptors may be stored in the memory 304 of the device 301 and may be returned by the processing circuitry 302 of the device 301 to the USB host controller 206 in response to USB descriptor requests received through the upstream-facing port 303. The one or more class-specific descriptors define the capabilities of the device 301 for audio bus communication and may indicate one or a combination of the audio bus protocol types supported by the device 301, the physical-layer signaling modes supported by the first downstream-facing port DFP-1 306 and the second downstream-facing port DFP-2 307, the number of downstream-facing ports provided by the device 301, the maximum number of audio bus peripheral devices connectable to each downstream-facing port, and/or any other capability information required by the SWI3S Function Class Driver 604 to correctly configure and manage the device 301.

The device class code, the device subclass code, the device protocol code, and the class-specific descriptor codes assigned to the device 301 may be assigned by the USB Implementers Forum following the standard USB device class definition procedures established by the USB Implementers Forum for defining new USB device classes. The process of defining a new USB device class through the USB Implementers Forum involves submission of a device class specification that defines the data structures, descriptors, requests, and communication protocols used by devices of the new class, and the assignment by the USB Implementers Forum of unique numerical codes for the device class, device subclass, device protocol, and any class-specific descriptor types defined in the device class specification. The assignment of codes by the USB Implementers Forum for the audio bus communication device class of the device 301 follows the same procedure as the assignment of codes for any other USB device class, such as the USB Human Interface Device class, the USB Audio Device class, or the USB Mass Storage class.

The end-to-end data flow through the software stack architecture 600 for audio bus data transmitted from the processor or system-on-chip 202 to an audio bus peripheral device may proceed as follows. The user application 601 generates audio bus data, such as a stream of pulse-code modulation audio samples for playback or a register write command for configuring an audio bus peripheral device and passes the audio bus data downward to the SWI3S peripheral driver 603 through the driver interface 602. The SWI3S peripheral driver 603 formats the audio bus data in accordance with the audio bus peripheral software stack conventions and passes the formatted audio bus data downward to the SWI3S Function Class Driver 604 through the driver interface 602. The SWI3S Function Class Driver 604 encapsulates the formatted audio bus data as the payload of one or more USB transactions and passes the USB transactions downward to the USB host controller driver 605. The USB host controller driver 605 schedules the USB transactions on the USB host controller 206, which transmits the USB transactions to the device 301 through the upstream-facing port 303 via the USB physical-layer transceiver 305 described with reference to FIG. 3.

The processing circuitry 302 of the device 301 extracts the audio bus data payload from the received USB transactions, converts the extracted audio bus data from the USB data format into the audio bus data format conforming to the audio bus protocol, and transmits the converted audio bus data to the addressed audio bus peripheral device through the first downstream-facing port DFP-1 306 or the second downstream-facing port DFP-2 307 via the audio bus protocol. The reverse data flow for audio bus data received from an audio bus peripheral device and delivered to the user application 601 proceeds through the software stack architecture 600 in the opposite direction.

In an example, the first downstream-facing port DFP-1 306 and/or the second downstream-facing port DFP-2 307 of the device 301 may each be coupled to a plurality of audio bus peripheral devices. In a multi-drop configuration, the plurality of audio bus peripheral devices coupled to a given downstream-facing port share a common physical connection to that downstream-facing port.

In the single-ended signaling configuration of the first downstream-facing port DFP-1 306, the common physical connection includes the clock line CLK and the data line DATA, to which each of the plurality of audio bus peripheral devices is connected in parallel. Each audio bus peripheral device in the multi-drop configuration receives the clock signal driven on the clock line CLK by the processing circuitry 302 of the device 301, and each audio bus peripheral device shares the data line DATA with all other audio bus peripheral devices on the same common physical connection. In the differential signaling configuration of the second downstream-facing port DFP-2 307, the common physical connection includes the differential pair D+ and D−, to which each of the plurality of audio bus peripheral devices is connected in parallel, with each audio bus peripheral device sharing the differential pair D+ and D− with all other audio bus peripheral devices on the same common physical connection.

The processing circuitry 302 of the device 301 may manage communication with each of the plurality of audio bus peripheral devices sharing a common physical connection to the first downstream-facing port DFP-1 306 or the second downstream-facing port DFP-2 307 by exploiting the addressing and scheduling mechanisms defined by the audio bus protocol. For example, the audio bus protocol assigns a unique address to each audio bus peripheral device connected to the common physical connection, and the processing circuitry 302 includes the address of the target audio bus peripheral device in each audio bus protocol control frame transmitted through the downstream-facing port to direct the control frame to the specific audio bus peripheral device for which the frame is intended.

In an example, the processing circuitry 302 transmits a register write command audio bus protocol frame on the data line DATA of the first downstream-facing port DFP-1 306 that carries in its address field the unique address assigned to a specific one of the plurality of audio bus peripheral devices sharing the common physical connection, so that only the addressed audio bus peripheral device acts on the register write command while the other audio bus peripheral devices sharing the common physical connection discard the frame. For audio payload data, the audio bus protocol transport layer scheduling mechanisms of the processing circuitry 302 allocate specific bit positions within the audio bus protocol frame structure to specific audio payload streams, with each audio payload stream associated with a specific audio bus peripheral device on the common physical connection.

In the multi-drop configuration, the half-duplex operation of the first downstream-facing port DFP-1306 and the second downstream-facing port DFP-2 307 may govern access to the common physical connection shared by the plurality of audio bus peripheral devices. The processing circuitry 302 of the device 301 may act as the manager entity on the audio bus and may be configured for coordinating access to the common physical connection among all audio bus peripheral devices sharing that connection. During a transmission interval, the processing circuitry 302 drives the signal lines of the downstream-facing port with an audio bus protocol frame addressed to one or more audio bus peripheral devices connected to the common physical connection, and all audio bus peripheral devices on the common physical connection receive the transmitted frame simultaneously. During a reception interval, a single audio bus peripheral device designated by the audio bus protocol scheduling mechanism of the processing circuitry 302 drives the signal lines of the common physical connection to transmit audio bus data to the processing circuitry 302, while all other audio bus peripheral devices on the common physical connection remain in a high-impedance receive state. The processing circuitry 302 may enforce the scheduling of transmission and reception intervals to ensure that no two devices on the common physical connection drive the signal lines of that connection simultaneously.

In some examples, the device 301 includes a plurality of downstream-facing ports, each coupled to one or more audio bus peripheral devices, enabling the device 301 to serve as a hub in the audio bus topology. As shown in FIG. 3, the device 301 can include the first downstream-facing port DFP-1 306 and the second downstream-facing port DFP-2 307 as separate downstream-facing ports, each connected to a respective audio bus peripheral device or group of audio bus peripheral devices. Each downstream-facing port of the device 301 may independently be configured for single-ended signaling, using a clock line and a data line as described with reference to the first downstream-facing port DFP-1 306, or for differential signaling, using a differential pair as described with reference to the second downstream-facing port DFP-2 307.

The independent configuration of each downstream-facing port may enable the device 301 to simultaneously support audio bus peripheral devices that require single-ended physical-layer signaling on one downstream-facing port and audio bus peripheral devices that require differential physical-layer signaling on another downstream-facing port. The processing circuitry 302 may manage the audio bus protocol communication on each downstream-facing port independently, acting as the audio bus manager entity for each separate downstream-facing port and maintaining separate addressing, scheduling, and timing contexts for the audio bus peripheral devices connected to each downstream-facing port.

In an example, the audio bus protocol implemented by the processing circuitry 302 of the device 301 is a MIPI Sound Wire protocol. In such an example, the first downstream-facing port DFP-1 306 of the device 301 provides a clock line CLK and a data line DATA that carry the MIPI Sound Wire clock signal and MIPI Sound Wire data signal respectively, in the single-ended signaling configuration as described herein. The processing circuitry 302 acts as the MIPI Sound Wire manager entity on the downstream side, generating MIPI Sound Wire frame structures including control and payload fields, driving the clock signal on the clock line CLK to provide timing for all MIPI Sound Wire peripheral devices connected to the first downstream-facing port DFP-1 306, and managing MIPI Sound Wire bus transactions including device enumeration, register access, and audio stream transport to and from the MIPI Sound Wire peripheral devices. The upstream-facing port 303 of the device 301 may accordingly communicate with the USB host controller 206 (e.g., the host controller 311) via USB transactions conforming to the USB specification, with the processing circuitry 302 translating between the USB data format of those USB transactions and the MIPI Sound Wire data format of the MIPI Sound Wire frames transmitted and received through the first downstream-facing port DFP-1 306.

In an example, the audio bus protocol implemented by the processing circuitry 302 of the device 301 is a MIPI Sound Wire I3S protocol. The MIPI Sound Wire I3S protocol, referred to herein as SWI3S, is a two-pin, multi-drop, half-duplex audio interconnect standard that carries both audio payload data and control data on a single link. For single-ended SWI3S, the first downstream-facing port DFP-1 306 of the device 301 provides the clock line CLK that carries the forwarded bit clock signal as a single-ended signal and the data line DATA that carries the SWI3S data signal as a single-ended signal shared between the processing circuitry 302 and the SWI3S peripheral devices. For differential SWI3S, the second downstream-facing port DFP-2 307 of the device 301 provides the differential pair D+ and D− that carries the SWI3S differential low-voltage signal.

The half-duplex operation of the first downstream-facing port DFP-1 306 and the second downstream-facing port DFP-2 307 corresponds directly to the half-duplex physical-layer behavior of SWI3S, in which the processing circuitry 302 and the SWI3S peripheral devices take turns driving the shared physical connection. The multi-drop topology, in which a plurality of SWI3S peripheral devices shares a common physical connection to the downstream-facing port of the device 301, corresponds to the multi-drop physical topology defined by the SWI3S specification, which supports up to twelve peripheral devices sharing a single SWI3S link. The combined transport of audio payload data and control data through the device 301 corresponds to the SWI3S link architecture in which audio payload streams and the control data stream are multiplexed together within the SWI3S frame structure on the same physical link.

The device architecture described herein is not limited to the MIPI Sound Wire protocol or the MIPI Sound Wire I3S protocol. The upstream-facing port 303, the processing circuitry 302, the first downstream-facing port DFP-1 306, and the second downstream-facing port DFP-2 307 of the device 301 may be configured for use with any audio bus protocol that defines its own physical-layer signaling characteristics, framing structure, addressing mechanism, and data formatting conventions for the transport of audio payload data and control data between a manager entity and one or more audio bus peripheral devices. In an example, the device 301 may be configured to implement any current or future audio interconnect standard defined by the MIPI Alliance or by another standards body, provided that the audio bus protocol implemented by the processing circuitry 302 defines a physical-layer interface that is compatible with the signal lines of the first downstream-facing port DFP-1 306 or the second downstream-facing port DFP-2 307 of the device 301.

In some examples, when the audio bus protocol implemented by the processing circuitry 302 of the device 301 is the SWI3S protocol, the device 301 acts as an SWI3S manager on the downstream side and as a USB device on the upstream side, providing a complete SWI3S topology integration within the platform without requiring SWI3S controller intellectual property to be integrated into the system-on-chip or the processor 202. On the downstream side, the processing circuitry 302 of the device 301 performs all functions of an SWI3S manager entity, including SWI3S cold start sequencing, SWI3S peripheral device discovery and address assignment, SWI3S transport pattern programming, SWI3S audio stream configuration and scheduling, and SWI3S bus error detection and recovery. On the upstream side, the processing circuitry 302 of the device 301 presents a USB device interface to the USB host controller 206, responding to USB transactions initiated by the USB host controller 206 through the upstream-facing port 303 in accordance with the USB device class assigned for audio bus communication.

In an example, upon power-on or connection of the device 301 to a USB port of the host device (e.g. the USB port 108), the processor or system-on-chip 202 initiates USB enumeration of the device 301 through the USB host controller 206 and the USB physical-layer transceiver 207. The USB host controller 206 may detect the connection of the device 301 by sensing the pull-up resistor asserted on the D+ or D− line of the USB connection by the USB physical-layer transceiver 305 of the device 301 through the upstream-facing port 303. This may signal to the USB host controller 206 that a full-speed or high-speed USB device has been connected. The USB host controller 206 issues a USB reset sequence on the USB connection to place the device 301 in the default state, assigns a unique USB device address to the device 301, and notifies the USB host controller driver 605 running on the processor or system-on-chip 202 that a new USB device has been connected at the assigned USB device address. The USB host controller driver 605 notifies the USB software stack running on the processor or system-on-chip 202, which initiates the USB enumeration sequence to determine the identity and capabilities of the device 301.

The processor or system-on-chip 202 may retrieve device identification information from the device 301 by directing the USB host controller 206 to issue a sequence of USB control transfer requests to the default control endpoint of the device 301 through the upstream-facing port 303. For example, the processor or system-on-chip 202 first directs the USB host controller 206 to issue a GET_DESCRIPTOR request with a descriptor type of DEVICE to retrieve the USB device descriptor of the device 301. The USB device descriptor returned by the processing circuitry 302 of the device 301 from the memory 304 through the upstream-facing port 303 may include the USB specification version supported by the device 301, the device class code, the device subclass code, and the device protocol code assigned for audio bus communication, a vendor identifier and a product identifier that uniquely identify the device 301, and the maximum packet size supported by the default control endpoint of the device 301. The processor or system-on-chip 202 reads the device class code, the device subclass code, and the device protocol code from the retrieved USB device descriptor to determine that the device 301 is a USB device belonging to the device class assigned for audio bus communication.

The processor or system-on-chip 202 may retrieve USB configuration information from the device 301 by directing the USB host controller 206 to issue a GET_DESCRIPTOR request with a descriptor type of CONFIGURATION to retrieve the USB configuration descriptor of the device 301 together with all subordinate USB interface descriptors and USB endpoint descriptors. The USB configuration descriptor returned by the processing circuitry 302 of the device 301 from the memory 304 describes the power requirements of the device 301, the number of USB interfaces supported by the device 301, and the configuration attributes of the device 301. Each USB interface descriptor returned by the processing circuitry 302 describes a functional interface of the device 301, including the interface class code, interface subclass code, interface protocol code, and the number of USB endpoints associated with the interface. Each USB endpoint descriptor returned by the processing circuitry 302 describes a specific USB endpoint of the device 301, including the endpoint address, endpoint type, transfer type, and maximum packet size supported by that endpoint. The processor or system-on-chip 202 uses the USB endpoint descriptors to determine the USB transfer types and endpoint addresses through which audio bus data and control data are exchanged with the device 301.

The processor or system-on-chip 202 may retrieve audio bus communication capability information from the device 301 by directing the USB host controller 206 to issue one or more GET_DESCRIPTOR requests with class-specific descriptor types assigned for audio bus communication to retrieve the one or more class-specific descriptors stored in the memory 304 of the device 301. The one or more class-specific descriptors returned by the processing circuitry 302 of the device 301 from the memory 304 through the upstream-facing port 303 in response to the GET_DESCRIPTOR requests may convey the capabilities of the device 301 for audio bus communication, including the audio bus protocol types supported by the processing circuitry 302, the physical-layer signaling modes supported by the first downstream-facing port DFP-1 306 and the second downstream-facing port DFP-2 307, the number of downstream-facing ports provided by the device 301, and the maximum number of audio bus peripheral devices connectable to each downstream-facing port.

The processor or system-on-chip 202 uses the capability information retrieved from the one or more class-specific descriptors to configure the SWI3S Function Class Driver 604, so that the SWI3S Function Class Driver 604 correctly manages communication with the SWI3S peripheral devices connected to the downstream-facing port of the device 301 in accordance with the capabilities reported by the device 301 in the one or more class-specific descriptors.

Following completion of USB enumeration, the processor or system-on-chip 202 can communicate with SWI3S peripheral devices connected to the downstream-facing port of the device 301 by issuing USB transactions to the device 301 through the USB host controller 206 via the USB host controller driver 605 and the SWI3S Function Class Driver 604.

To configure a SWI3S peripheral device, the processor or system-on-chip 202 executes the SWI3S peripheral driver 603, which generates a register write command addressed to the SWI3S peripheral device and passes the register write command downward through the driver interface 602 to the new SWI3S Function Class Driver 604. The SWI3S Function Class Driver 604 encapsulates the register write command as the payload of a USB control transfer or USB bulk transfer directed to the device 301 at the endpoint address identified from the USB endpoint descriptor retrieved during USB enumeration and passes the USB transfer downward to the USB host controller driver 605. The USB host controller driver 605 schedules the USB transfer on the USB host controller 206, which transmits the USB transfer to the device 301 through the upstream-facing port 303. To receive audio payload data captured by a SWI3S peripheral device, the processor or system-on-chip 202 directs the USB host controller 206 to issue USB isochronous transfer transactions to the isochronous endpoint of the device 301 at scheduled intervals, with the processing circuitry 302 of the device 301 returning captured audio payload data extracted from SWI3S frames received through the downstream-facing port as the data packet payload of each USB isochronous transfer response.

The processing circuitry 302 of the device 301 may perform protocol translation between the USB transaction layer on the upstream side and the audio bus protocol (e.g., SWI3S physical and transport layers) on the downstream side by maintaining two concurrent protocol engines and transferring audio bus data between those protocol engines through an internal translation pathway.

On the upstream side, the USB device protocol engine of the processing circuitry 302 implements the USB device state machine defined by the USB specification, managing the USB device states from the powered state through the default state, the addressed state, and the configured state in response to USB reset, USB SET_ADDRESS, and USB SET_CONFIGURATION control transfers received from the USB host controller 206 through the upstream-facing port 303. The USB device protocol engine can service USB control transfer requests directed to the default control endpoint of the device 301 by retrieving the requested USB descriptors from the memory 304 and returning the retrieved descriptors to the USB host controller 206 as USB control transfer response data packets through the upstream-facing port 303. The USB device protocol engine further manages USB isochronous endpoints, USB bulk endpoints, and USB interrupt endpoints of the device 301, receiving incoming USB transfer data packets from the USB host controller 206 and providing outgoing USB transfer data packets to the USB host controller 206 at each endpoint in accordance with the USB transfer scheduling managed by the USB host controller 206.

The processing circuitry 302 translates USB isochronous transfer data received from the USB host controller 206 through the upstream-facing port 303 into SWI3S audio payload stream data for transmission to SWI3S peripheral devices through the downstream-facing port of the device 301. A USB isochronous transfer directed to the device 301 may carry, as the payload of its data packet, a sequence of pulse-code modulation audio samples formatted in accordance with the USB data format defined for the isochronous endpoint of the device 301. The processing circuitry 302 may extract the pulse-code modulation audio sample sequence from the data packet payload of the received USB isochronous transfer and map the extracted pulse-code modulation audio samples into the SWI3S transport pattern allocated for the corresponding audio payload stream within the SWI3S frame structure. The SWI3S transport pattern defines the row and column positions within the SWI3S frame at which the bits of each pulse-code modulation audio sample are transmitted on the signal lines of the first downstream-facing port DFP-1 306 or the second downstream-facing port DFP-2 307. The processing circuitry 302 drives the signal lines of the downstream-facing port with the SWI3S frame carrying the mapped pulse-code modulation audio samples in synchronization with the SWI3S row clock generated by the SWI3S manager protocol engine of the processing circuitry 302. Conversely, the processing circuitry 302 extracts pulse-code modulation audio samples from the SWI3S transport pattern positions of SWI3S frames received from SWI3S peripheral devices through the downstream-facing port, assembles the extracted pulse-code modulation audio samples into a USB isochronous transfer data packet payload formatted in accordance with the USB data format defined for the isochronous endpoint of the device 301, and returns the USB isochronous transfer data packet to the USB host controller 206 through the upstream-facing port 303.

The processing circuitry 302 may translate USB control transfer and USB bulk transfer data received from the USB host controller 206 through the upstream-facing port 303 into SWI3S command protocol transactions for transmission to SWI3S peripheral devices through the downstream-facing port of the device 301. A USB control transfer or USB bulk transfer directed to the device 301 may carry, as the payload of its data packet, an audio bus control command formatted in accordance with the USB class-specific request format defined for the device class of the device 301. The audio bus control command may specify the SWI3S peripheral device address, the type of SWI3S command protocol transaction to be executed, and the register address and data value for register write commands or the register address for register read commands. The processing circuitry 302 extracts the audio bus control command from the data packet payload of the received USB transfer, and may construct a SWI3S command protocol frame encoding the extracted command in the SWI3S command data stream format, and transmit the SWI3S command protocol frame on the data line DATA of the first downstream-facing port DFP-1 306 or on the differential pair D+ and D− of the second downstream-facing port DFP-2 307 during a transmission interval of the SWI3S half-duplex cycle. For register read commands, the processing circuitry 302 may schedule a SWI3S command response reception interval following the transmission of the SWI3S command protocol frame, receive the SWI3S command response frame from the addressed SWI3S peripheral device during the reception interval, extracts the register value from the SWI3S command response frame, encapsulate the extracted register value as the payload of a USB transfer response data packet, and return the USB transfer response data packet to the USB host controller 206 through the upstream-facing port 303.

The processing circuitry 302 may manage the timing relationship between the USB transaction layer on the upstream side and the SWI3S physical layer on the downstream side to ensure that audio payload data and control data are transferred through the device 301 without loss or corruption. On the downstream side, the SWI3S manager protocol engine of the processing circuitry 302 generates the SWI3S row clock at a row rate that is programmed in accordance with the SWI3S transport pattern parameters configured during SWI3S initialization, and drives the clock line CLK of the first downstream-facing port DFP-1 306 with the forwarded bit clock signal derived from the SWI3S row clock for the single-ended FBCSE PHY configuration, or embeds the Row Sync Sequence within the SWI3S frame structure transmitted on the differential pair D+ and D− of the second downstream-facing port DFP-2 f307 or the differential DLV PHY configuration.

On the upstream side, the USB device protocol engine of the processing circuitry 302 responds to USB isochronous transfer requests from the USB host controller 206 at the USB frame or microframe interval defined by the USB specification. The processing circuitry 302 maintains internal buffers between the USB device protocol engine and the SWI3S manager protocol engine to absorb the timing difference between the USB isochronous transfer interval and the SWI3S frame interval, ensuring that pulse-code modulation audio samples delivered by the USB host controller 206 at the USB isochronous transfer rate are presented to the SWI3S transport layer at the SWI3S row rate without underflow or overflow of the internal buffers, and that pulse-code modulation audio samples captured at the SWI3S row rate are presented to the USB host controller 206 at the USB isochronous transfer rate without loss.

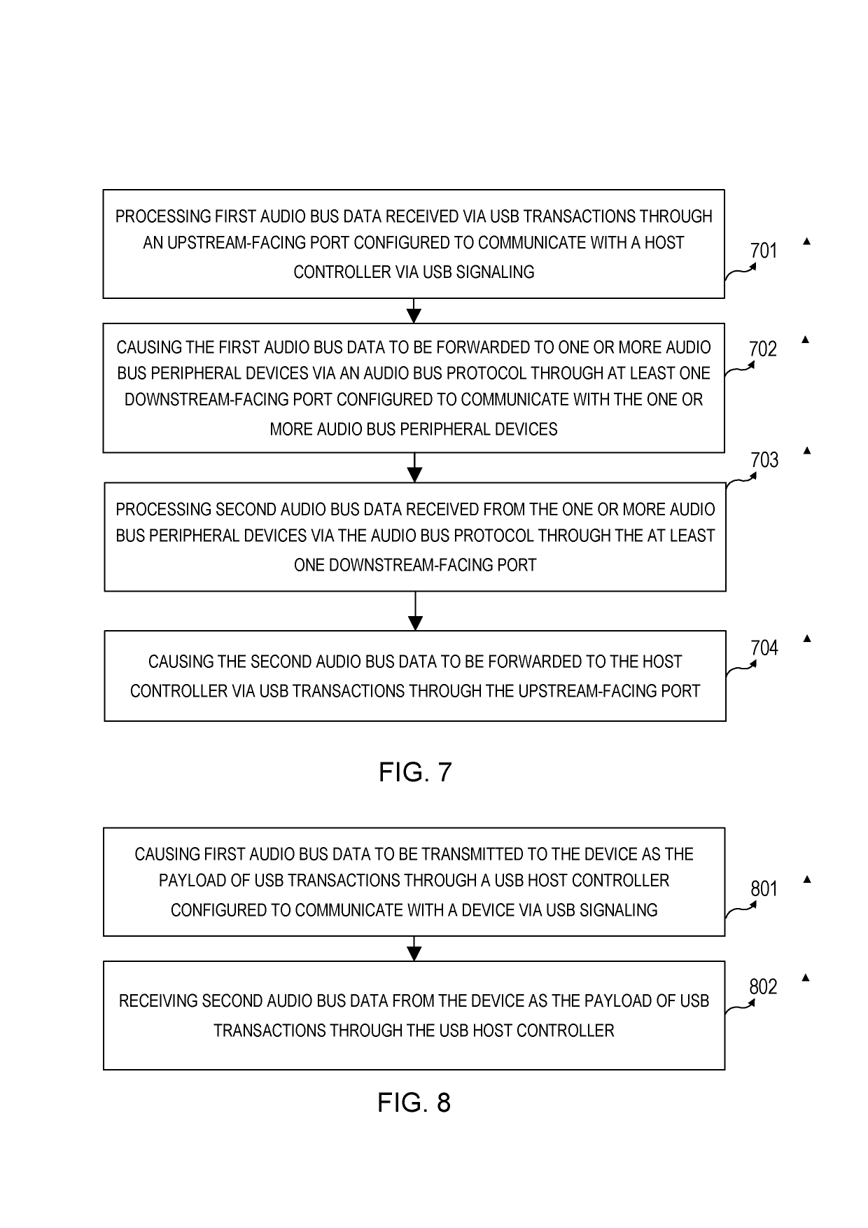

FIG. 7 shows an example of a method. The method may include: processing 701 first audio bus data received via USB transactions through an upstream-facing port configured to communicate with a host controller via USB signaling; causing 702 the first audio bus data to be forwarded to one or more audio bus peripheral devices via an audio bus protocol through at least one downstream-facing port configured to communicate with the one or more audio bus peripheral devices, processing 703 second audio bus data received from the one or more audio bus peripheral devices via the audio bus protocol through the at least one downstream-facing port; and causing 704 the second audio bus data to be forwarded to the host controller via USB transactions through the upstream-facing port. A non-transitory computer-readable medium may include instructions which, if executed by a processor, cause the processor to perform the method.

FIG. 8 shows an example of a method for a USB device. The method may include: causing 801 first audio bus data to be transmitted to the device as the payload of USB transactions through a USB host controller configured to communicate with a device via USB signaling; and receiving 802 second audio bus data from the device as the payload of USB transactions through the USB host controller. A non-transitory computer-readable medium may include instructions which, if executed by a processor, cause the processor to perform the method.

The detailed description refers to the accompanying drawings that show, by way of illustration, specific details and aspects of this disclosure in which the disclosure may be practiced. Other aspects may be utilized and structural, logical, and electrical changes may be made without departing from the scope of the disclosure. The various aspects of this disclosure are not necessarily mutually exclusive, as some aspects of this disclosure can be combined with one or more other aspects of this disclosure to form new aspects.

Throughout the drawings, it should be noted that like reference numbers are used to depict the same or similar elements, features, and structures, unless otherwise noted.

The word "exemplary" is used herein to mean "serving as an example, instance, or illustration". Any aspect or design described herein as "exemplary" is not necessarily to be construed as preferred or advantageous over other aspects or designs.

The phrase “at least one” and “one or more” may be understood to include a numerical quantity greater than or equal to one (e.g., one, two, three, four, […], etc.). The phrase "at least one of" with regard to a group of elements may be used herein to mean at least one element from the group consisting of the elements. For example, the phrase "at least one of" with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, […], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

Further, spatially relative terms, such as "beneath," "below," "lower," "above," "upper" and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

As utilized herein, terms "module", "component," "system," "circuit," "element," "slice," "circuitry," and the like are intended to refer to a set of one or more electronic components, a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuits can reside within the same circuitry, and circuitry can be localized on one computer and/or distributed between two or more computers. A set of elements or a set of other circuits can be described herein, in which the term "set" can be interpreted as "one or more."

It will be understood that when an element is referred to as being "connected" or "coupled" to another element, it can be physically connected or coupled to the other element such that current and/or electromagnetic radiation (e.g., a signal) can flow along a conductive path formed by the elements. Intervening conductive, inductive, or capacitive elements may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being "applied" to an element, the voltage, current, or signal may be conducted to the element by way of a physical connection or by way of capacitive, electro-magnetic, or inductive coupling that does not involve a physical connection.

The following examples pertain to further aspects of this disclosure.

Example 1 includes the subject matter of a device including: an upstream-facing port configured to communicate with a host controller via USB signaling; at least one downstream-facing port configured to communicate with one or more audio bus peripheral devices; and processing circuitry configured to: process first audio bus data received via USB transactions through the upstream-facing port; cause the first audio bus data to be forwarded to the one or more audio bus peripheral devices via the audio bus protocol through the at least one downstream-facing port, process second audio bus data received from the one or more audio bus peripheral devices via the audio bus protocol through the at least one downstream-facing port; and cause the second audio bus data to be forwarded to the host controller via USB transactions through the upstream-facing port.

Example 2 may include the subject matter of example 1, wherein the upstream-facing port is configured to communicate with the host controller via a USB 2.0 connection.

Example 3 may include the subject matter of example 2, wherein the USB 2.0 connection is an embedded USB 2.0 connection.

Example 4 may include the subject matter of any one of examples 1 to 3, wherein the device is recognized by the host controller as a USB device having a device class assigned for audio bus communication.

Example 5 may include the subject matter of example 4, wherein the device class is associated with a device class code, a device subclass code, and a device protocol code assigned for audio bus communication.

Example 6 may include the subject matter of any one of examples 4 to 5, may further include a memory configured to store one or more class-specific descriptors indicating capabilities of the device for audio bus communication, wherein the processing circuitry is configured to provide the one or more class-specific descriptors to the host controller in response to USB descriptor requests received through the upstream-facing port.

Example 7 may include the subject matter of any one of examples 1 to 6, wherein the processing circuitry is further configured to execute a software interface between a USB software stack associated with the host controller and an audio bus peripheral software stack associated with the one or more audio bus peripheral devices.

Example 8 may include the subject matter of any one of examples 1 to 7, wherein the processing circuitry is configured to communicate audio bus data to and from the host controller exclusively via USB transactions conforming to a USB specification through the upstream-facing port.

Example 9 may include the subject matter of any one of examples 1 to 8, wherein the at least one downstream-facing port is configured such that transmission of audio bus data from the device to the one or more audio bus peripheral devices and reception of audio bus data from the one or more audio bus peripheral devices to the device occur alternately on a shared physical connection.

Example 10 may include the subject matter of any one of examples 1 to 9, wherein the at least one downstream-facing port includes a clock line and a data line for communication with each of the one or more audio bus peripheral devices.

Example 11 may include the subject matter of example 10, wherein the at least one downstream-facing port is configured to transmit a clock signal as a single-ended signal on the clock line and to transmit and receive a data signal as a single-ended signal on the data line.

Example 12 may include the subject matter of any one of examples 1 to 9, wherein the at least one downstream-facing port includes a differential pair of lines, and wherein the at least one downstream-facing port is configured to transmit and receive audio bus data as a differential signal across the differential pair of lines.

Example 13 may include the subject matter of any one of examples 1 to 12, wherein the audio bus data includes both audio payload data and control data.

Example 14 may include the subject matter of any one of examples 1 to 13, wherein the at least one downstream-facing port is coupled to a plurality of audio bus peripheral devices sharing a common physical connection to the at least one downstream-facing port, and wherein the processing circuitry is configured to manage communication with each of the plurality of audio bus peripheral devices on the common physical connection.

Example 15 may include the subject matter of any one of examples 1 to 14, may further include a USB physical-layer transceiver coupled to the upstream-facing port for communication with the host controller.

Example 16 may include the subject matter of any one of examples 1 to 15, wherein the processing circuitry is configured to translate between a USB data format received through the upstream-facing port and an audio bus data format transmitted through the at least one downstream-facing port.

Example 17 may include the subject matter of any one of examples 1 to 16, wherein the audio bus protocol includes a MIPI Sound Wire protocol or a MIPI Sound Wire I3S (SWI3S) protocol.

Example 18 may include the subject matter of a USB host device including: a USB host controller configured to communicate with a device via USB signaling; and a processor configured to: cause first audio bus data to be transmitted to the device as the payload of USB transactions through the USB host controller; and receive second audio bus data from the device as the payload of USB transactions through the USB host controller.

Example 19 may include the subject matter of example 18, wherein the processor is configured to identify, from one or more USB descriptors received from the device during USB enumeration, a device class assigned for audio bus communication.

Example 20 may include the subject matter of example 19, wherein the one or more USB descriptors include a device class code, a device subclass code, and a device protocol code assigned for audio bus communication, and wherein the processor is configured to load a software interface for the device based on the device class code, the device subclass code, and the device protocol code.

Example 21 may include the subject matter of example 19 or 20, wherein the processor is configured to retrieve one or more class-specific descriptors from the device through the USB host controller during USB enumeration, wherein the one or more class-specific descriptors indicate capabilities of the device for audio bus communication.

Example 22 may include the subject matter of any one of examples 18 to 21, wherein the audio bus data communicated with the device via USB transactions corresponds to communication between the device and one or more audio bus peripheral devices via a MIPI Sound Wire protocol or a MIPI Sound Wire I3S protocol.

Example 23 may include a system including, the device of any one of examples 1 to 17 and the USB device of any one of examples 18 to 22.

Example 24 may include the subject matter of a method including: processing first audio bus data received via USB transactions through an upstream-facing port configured to communicate with a host controller via USB signaling; causing the first audio bus data to be forwarded to one or more audio bus peripheral devices via an audio bus protocol through at least one downstream-facing port configured to communicate with the one or more audio bus peripheral devices, processing second audio bus data received from the one or more audio bus peripheral devices via the audio bus protocol through the at least one downstream-facing port; and causing the second audio bus data to be forwarded to the host controller via USB transactions through the upstream-facing port.

Example 25 may include the subject matter of example 24, wherein the upstream-facing port is configured to communicate with the host controller via a USB 2.0 connection.

Example 26 may include the subject matter of example 25, wherein the USB 2.0 connection is an embedded USB 2.0 connection.

Example 27 may include the subject matter of any one of examples 24 to 27, may further include recognizing, by the host controller, as a USB device having a device class assigned for audio bus communication.

Example 28 may include the subject matter of example 27, wherein the device class is associated with a device class code, a device subclass code, and a device protocol code assigned for audio bus communication.

Example 29 may include the subject matter of any one of examples 27 to 28, may further include storing, by a memory, one or more class-specific descriptors indicating capabilities of the device for audio bus communication, wherein the processing circuitry is configured to provide the one or more class-specific descriptors to the host controller in response to USB descriptor requests received through the upstream-facing port.

Example 30 may include the subject matter of any one of examples 24 to 29, may further include executing a software interface between a USB software stack associated with the host controller and an audio bus peripheral software stack associated with the one or more audio bus peripheral devices.

Example 31 may include the subject matter of any one of examples 24 to 30, may further include communicating audio bus data to and from the host controller exclusively via USB transactions conforming to a USB specification through the upstream-facing port.

Example 32 may include the subject matter of any one of examples 24 to 31, wherein the at least one downstream-facing port is configured such that transmission of audio bus data from the device to the one or more audio bus peripheral devices and reception of audio bus data from the one or more audio bus peripheral devices to the device occur alternately on a shared physical connection.

Example 33 may include the subject matter of any one of examples 24 to 32, wherein the at least one downstream-facing port includes a clock line and a data line for communication with each of the one or more audio bus peripheral devices.

Example 34 may include the subject matter of example 33, may further include transmitting, via the at least one downstream-facing port, a clock signal as a single-ended signal on the clock line and to transmit and receive a data signal as a single-ended signal on the data line.

Example 35 may include the subject matter of any one of examples 24 to 32, wherein the at least one downstream-facing port includes a differential pair of lines, and the method further includes transmitting and receiving, by the at least one downstream-facing port, audio bus data as a differential signal across the differential pair of lines.

Example 36 may include the subject matter of any one of examples 24 to 35, wherein the audio bus data includes both audio payload data and control data.

Example 37 may include the subject matter of any one of examples 24 to 36, wherein the at least one downstream-facing port is coupled to a plurality of audio bus peripheral devices sharing a common physical connection to the at least one downstream-facing port, and wherein the method includes managing communication with each of the plurality of audio bus peripheral devices on the common physical connection.

Example 38 may include the subject matter of any one of examples 24 to 37, may further include translating between a USB data format received through the upstream-facing port and an audio bus data format transmitted through the at least one downstream-facing port.

Example 39 may include the subject matter of any one of examples 24 to 38, wherein the audio bus protocol includes a MIPI Sound Wire protocol or a MIPI Sound Wire I3S (SWI3S) protocol.

Example 40 may include the subject matter of a method for a USB host device, the method including: causing first audio bus data to be transmitted to the device as the payload of USB transactions through a USB host controller configured to communicate with a device via USB signaling; and receiving second audio bus data from the device as the payload of USB transactions through the USB host controller.

Example 41 may include the subject matter of example 40, may further include identifying, from one or more USB descriptors received from the device during USB enumeration, a device class assigned for audio bus communication.

Example 42 may include the subject matter of example 41, wherein the one or more USB descriptors include a device class code, a device subclass code, and a device protocol code assigned for audio bus communication, and wherein the method further includes loading a software interface for the device based on the device class code, the device subclass code, and the device protocol code.

Example 43 may include the subject matter of example 41 or 42, may further include retrieving one or more class-specific descriptors from the device through the USB host controller during USB enumeration, wherein the one or more class-specific descriptors indicate capabilities of the device for audio bus communication.

Example 44 may include the subject matter of any one of examples 40 to 43, wherein the audio bus data communicated with the device via USB transactions corresponds to communication between the device and one or more audio bus peripheral devices via a MIPI Sound Wire protocol or a MIPI Sound Wire I3S protocol.

Example 45 may include a non-transitory computer-readable medium including instructions which, if executed by a processor, cause the processor to perform the method of any one of examples 24 to 39 or the method of any one of examples 40 to 44.

Example 46 may include an apparatus including means to perform the methods of any one of examples 24 to 44.

What is claimed is:

1. A device comprising:
an upstream-facing port configured to communicate with a host controller via USB signaling;
at least one downstream-facing port configured to communicate with one or more audio bus peripheral devices; and
processing circuitry configured to:
process first audio bus data received via USB transactions through the upstream-facing port;
cause the first audio bus data to be forwarded to the one or more audio bus peripheral devices via the audio bus protocol through the at least one downstream-facing port,
process second audio bus data received from the one or more audio bus peripheral devices via the audio bus protocol through the at least one downstream-facing port; and
cause the second audio bus data to be forwarded to the host controller via USB transactions through the upstream-facing port.

2. The device of claim 1, wherein the upstream-facing port is configured to communicate with the host controller via a USB 2.0 connection.

3. The device of claim 2, wherein the USB 2.0 connection is an embedded USB 2.0 connection.

4. The device of claim 1, wherein the device is recognized by the host controller as a USB device having a device class assigned for audio bus communication.

5. The device of claim 4, wherein the device class is associated with a device class code, a device subclass code, and a device protocol code assigned for audio bus communication.

6. The device of claim 4, further comprising a memory configured to store one or more class-specific descriptors indicating capabilities of the device for audio bus communication, wherein the processing circuitry is configured to provide the one or more class-specific descriptors to the host controller in response to USB descriptor requests received through the upstream-facing port.

7. The device of claim 1, wherein the processing circuitry is configured to communicate audio bus data to and from the host controller exclusively via USB transactions conforming to a USB specification through the upstream-facing port.

8. The device of claim 1, wherein the at least one downstream-facing port is configured such that transmission of audio bus data from the device to the one or more audio bus peripheral devices and reception of audio bus data from the one or more audio bus peripheral devices to the device occur alternately on a shared physical connection.

9. The device of claim 1, wherein the at least one downstream-facing port comprises a clock line and a data line for communication with each of the one or more audio bus peripheral devices.

10. The device of claim 1, wherein the at least one downstream-facing port comprises a differential pair of lines, and wherein the at least one downstream-facing port is configured to transmit and receive audio bus data as a differential signal across the differential pair of lines.

11. The device of claim 1, wherein the processing circuitry is configured to translate between a USB data format received through the upstream-facing port and an audio bus data format transmitted through the at least one downstream-facing port.

12. The device of claim 1, wherein the audio bus protocol comprises a MIPI SoundWire protocol or a MIPI SoundWire I3S (SWI3S) protocol.

13. A USB host device comprising:
a USB host controller configured to communicate with a device via USB signaling; and
a processor configured to:
cause first audio bus data to be transmitted to the device as the payload of USB transactions through the USB host controller; and
receive second audio bus data from the device as the payload of USB transactions through the USB host controller.

14. The USB host device of claim 13, wherein the processor is configured to identify, from one or more USB descriptors received from the device during USB enumeration, a device class assigned for audio bus communication.

15. The USB host device of claim 14, wherein the one or more USB descriptors comprise a device class code, a device subclass code, and a device protocol code assigned for audio bus communication, and wherein the processor is configured to load a software interface for the device based on the device class code, the device subclass code, and the device protocol code.

16. The USB host device of claim 14, wherein the processor is configured to retrieve one or more class-specific descriptors from the device through the USB host controller during USB enumeration, wherein the one or more class-specific descriptors indicate capabilities of the device for audio bus communication.

17. The USB host device of claim 13, wherein the audio bus data communicated with the device via USB transactions corresponds to communication between the device and one or more audio bus peripheral devices via a MIPI SoundWire protocol or a MIPI SoundWire I3S protocol.

18. A method comprising:
processing first audio bus data received via USB transactions through an upstream-facing port configured to communicate with a host controller via USB signaling;
causing the first audio bus data to be forwarded to one or more audio bus peripheral devices via an audio bus protocol through at least one downstream-facing port configured to communicate with the one or more audio bus peripheral devices,
processing second audio bus data received from the one or more audio bus peripheral devices via the audio bus protocol through the at least one downstream-facing port; and
causing the second audio bus data to be forwarded to the host controller via USB transactions through the upstream-facing port.

19. The method of claim 18, wherein the at least one downstream-facing port is coupled to a plurality of audio bus peripheral devices sharing a common physical connection to the at least one downstream-facing port, and wherein the method comprises managing communication with each of the plurality of audio bus peripheral devices on the common physical connection.

20. The method of claim 18, wherein the at least one downstream-facing port is configured such that transmission of audio bus data from the device to the one or more audio bus peripheral devices and reception of audio bus data from the one or more audio bus peripheral devices to the device occur alternately on a shared physical connection.
